(19) United States
(12) Patent Application Publication
(10) Pub. No.: US 2022/0014895 A1
(43) Pub. Date: Jan. 13, 2022

(54) SPATIOTEMPORAL ANALYSIS FOR EMERGENCY RESPONSE

(71) Applicant: RapidSOS, Inc., New York, NY (US)

(72) Inventors: Nicholas Edward Horelik, Long Island, NY (US); Gabriel Mahoney, Brooklyn, NY (US); Lucas Richard Eager Leavitt, Forest Hills, NY (US); William Thomas Guthrie, Fairplay, CO (US); Nicole Leonard, Longmont, CO (US); Andrew Lindstrom Gillespie, Brooklyn, NY (US); Martín Andrés Minnoni, Buenos Aires (AR)

(21) Appl. No.: 17/374,878

(22) Filed: Jul. 13, 2021

Related U.S. Application Data
(60) Provisional application No. 63/051,247, filed on Jul. 13, 2020.
(60) Provisional application No. 63/055,708, filed on Jul. 23, 2020.

(51) Int. Cl. H04W 4/90; G06F 16/29; G08B 25/10; H04W 4/029

(52) U.S. Cl. CPC H04W 4/90; H04W 4/029; G08B 25/10; G06F 16/29

(57) ABSTRACT

Described herein are systems, devices, methods, and media for emergency spatiotemporal analysis. One or more emergency response resources may be returned, transmitted and displayed. In some embodiments, emergency metrics may be determined and displayed.

### CROSS-REFERENCE

This application claims the benefit of U.S. Provisional Application No. 63/051,247, filed Jul. 13, 2020, and U.S. Provisional Application No. 63/055,708, filed Jul. 23, 2020, each of which are incorporated herein in their entirety by reference.

### BACKGROUND OF THE INVENTION

A person in an emergency situation may request help using a mobile communication device such as a cell phone to dial a designated emergency number like 9-1-1 or a direct access phone number for the local emergency service provider (e.g., an emergency dispatch center). This call is assigned to one or more first responders by the emergency service provider.

### SUMMARY OF THE INVENTION

One advantage provided by the systems, servers, devices, methods, and media of the instant application is the ability to perform emergency spatiotemporal analyses to identify emergency response resources or elements in the vicinity of an emergency. The identified emergency response resources or elements can then be communicated to one or more emergency service providers (ESPs), which can then use the identified emergency response resources to more efficiently or effectively respond to the emergency. Emergency response elements may include additional emergencies, past or present, or emergency response resources, such as first responders or emergency response assets. Another advantage provided by the systems, servers, devices, methods, and media of the instant application is the ability to determine relational attributes of an emergency response element, such as a landmark location for an emergency alert, or if an emergency alert is representative of an auto emergency.

In one aspect, disclosed herein is a method for providing emergency data comprising: defining a representative area for emergency spatiotemporal analysis; identifying one or more emergency response resources located within the representative area within an appropriate timeframe; transmitting the emergency data comprising the one or more emergency response resources located within the representative area; and displaying the emergency data comprising the one or more emergency response resources within an interactive map. In some embodiments, the appropriate timeframe is longer for static resources as compared to dynamic resources. In some embodiments, the representative area is a circular shape, a regular or irregular polygon, a jurisdictional boundary for a public safety agency. In some embodiments, the representative area is a regional agency, wherein the regional agency oversees a plurality of emergency network entities, each emergency network entity corresponding to a given geographic boundary and wherein the emergency data is aggregated among the plurality of emergency network entities. In some embodiments, defining the representative area for emergency spatiotemporal analysis comprises receiving an emergency alert comprising an emergency location and generating a proximity area around the emergency location. In some embodiments, generating the proximity area around the emergency location comprises applying a radius around the emergency location. In some embodiments, the method further comprises expanding the proximity area around the emergency location if no emergency response resources are identified within the proximity area. In some embodiments, the method further comprises providing a jurisdictional view for an emergency service provider, wherein the representative area is defined by one or more jurisdictional boundaries for the emergency service provider. In some embodiments, the representative area is a regional agency, wherein the regional agency oversees a plurality of emergency network entities, each emergency network entity corresponding to a given geographic boundary.

In another aspect, disclosed herein is a system comprising a processor and non-transitory computer readable storage medium including instructions that, when executed by the processor, causes the processor to: define a representative area for emergency spatiotemporal analysis; identify one or more emergency response resources located within the representative area within an appropriate timeframe; transmit the emergency data comprising the one or more emergency response resources located within the representative area; and display the emergency data comprising the one or more emergency response resources within an interactive map.

In another aspect, disclosed herein is a non-transitory computer readable storage medium including instructions that, when executed by a processor, causes the processor to: define a representative area for emergency spatiotemporal analysis; identify one or more emergency response resources located within the representative area within an appropriate timeframe; transmit the emergency data comprising the one or more emergency response resources located within the representative area; and display the emergency data comprising the one or more emergency response resources within an interactive map.

Disclosed herein, in another aspect, is a method for providing emergency data comprising: defining a representative area for emergency spatiotemporal analysis; identifying one or more emergency response resources located within the representative area within a timeframe, wherein the length of the timeframe is based at least partly on information about the one or more emergency response resources or user input; transmitting the emergency data comprising the one or more emergency response resources located within the representative area; and displaying the emergency data comprising the one or more emergency response resources within an interactive map. In some embodiments, the timeframe is based on type of resource. In some embodiments, the timeframe cuts off based on expiration date or maintenance date. In some embodiments, the timeframe is longer for static resources as compared to dynamic resources. In some embodiments, the representative area is a circular shape, a regular or irregular polygon, a jurisdictional boundary for a public safety agency.6. In some embodiments, the representative area is a regional agency, wherein the regional agency oversees a plurality of emergency service providers, each emergency service provider corresponding to a given geographic boundary and wherein the emergency data is aggregated among the plurality of emergency service providers. In some embodiments, defining the representative area for emergency spatiotemporal analysis comprises receiving an emergency alert comprising an emergency location and generating a proximity area around the emergency location. In some embodiments, generating the proximity area around the emergency location comprises applying a radius around the emergency location. In some embodiments, the method further comprises expanding the proximity area around the emergency location if no emergency response resources are identified within the proximity area. In some embodiments, the method further comprises providing a jurisdictional view for an emergency service provider, wherein the representative area is defined by one or more jurisdictional boundaries for the emergency service provider. In some embodiments, the method further comprises searching in a responder information database for emergency resources within the representative area and the timeframe, wherein the responder information database comprises information about responders, vehicles and facilities. In some embodiments, the method further comprises searching in a safety asset database for emergency resources within the representative area and the timeframe. In some embodiments, safety assets comprise cameras, Iot devices, alarm sensors, door locks, fire extinguishers, drones, fire hydrants, AEDs, eye wash stations, first-aid kits, chemical burn kits, etc. In some embodiments, the method further comprises providing a prompt to a user to check on the status of an emergency resource.

In another aspect, disclosed herein is a method for providing emergency metrics comprising: defining a representative area for emergency spatiotemporal analysis; identifying one or more emergency alerts within the representative area within a defined timeframe; aggregating the emergency alerts into an emergency metric; transmitting emergency metric associated with the one or more emergency alerts within the representative area to an emergency service provider; and displaying the one or more emergency metric within an interactive map at the emergency service provider, wherein the representative area is within one or more jurisdictional boundaries of the emergency service provider. In some embodiments, the defined timeframe is 1-14 days for identification of emergency hotspots. In some embodiments, the one or more emergency alerts are emergency calls that were initiated within the representative area. In some embodiments, the one or emergency alerts are emergency service requests that are sent via SMS messages, internet-based messaging, APIs, wherein the one or more emergency alerts are not accompanied by an emergency call. In some embodiments, the one or more emergency alerts are aggregated into an emergency metric with a plurality of emergency alerts from outside the one or more jurisdictional boundaries of the emergency service provider. In some embodiments, the emergency metric is one or more of call volume, call duration, time between calls, percentage of repeated calls, total number of emergency service requests, percentage of emergency service requests declined, calls shared with neighboring ECCs, call source, spoken language, emergency type, emergency location type. In some embodiments, the emergency metric for an ESP is compared with peer agencies.

In another aspect, disclosed herein is a method for providing emergency assistance comprising: defining a representative area for emergency spatiotemporal analysis; identifying one or more emergency alerts within the representative area within a defined timeframe; transmitting emergency data associated with the one or more emergency alerts within the representative area to an emergency service provider; and displaying the one or more emergency alerts as emergency incidents within an interactive map at the emergency service provider, wherein the representative area is within one or more jurisdictional boundaries of the emergency service provider. In some embodiments, the defined timeframe is 1-14 days for identification of emergency hotspots. In some embodiments, the one or more emergency alerts are emergency calls that were initiated within the representative area. In some embodiments, the one or emergency alerts are emergency service requests that are sent via SMS messages, internet-based messaging, APIs, wherein the one or more emergency alerts are not accompanied by an emergency call. In some embodiments, the one or more emergency alerts are aggregated into an emergency metric with a plurality of emergency alerts from outside the one or more jurisdictional boundaries of the emergency service provider. In some embodiments, the emergency metric is one or more of call volume, call duration, time between calls, percentage of repeated calls, total number of emergency service requests, percentage of emergency service requests declined, calls shared with neighboring ECCs, call source, spoken language, emergency type, emergency location type.

In another aspect, disclosed herein is a system comprising a processor and non-transitory computer readable storage medium including instructions that, when executed by the processor, causes the processor to: define a representative area for emergency spatiotemporal analysis; identify one or more emergency alerts within the representative area within a defined timeframe; transmit emergency data associated with the one or more emergency alerts within the representative area to an emergency service provider; and display the one or more emergency alerts as emergency incidents within an interactive map at the emergency service provider, wherein the representative area is within one or more jurisdictional boundaries of the emergency service provider.

In another aspect, disclosed herein is a non-transitory computer readable storage medium including instructions that, when executed by a processor, causes the processor to: define a representative area for emergency spatiotemporal analysis; identify one or more emergency alerts within the representative area within a defined timeframe; transmit emergency data associated with the one or more emergency alerts within the representative area to an emergency service provider; and display the one or more emergency alerts as emergency incidents within an interactive map at the emergency service provider, wherein the representative area is within one or more jurisdictional boundaries of the emergency service provider.

In another aspect, disclosed herein is a method for providing emergency assistance, the method comprising: determining a representative area for emergency spatiotemporal analysis; identifying one or more emergency response resources within the representative area; transmitting the one or more emergency alerts or emergency response resources identified within the representative area to an emergency service provider (ESP); and displaying the one or more emergency alerts or emergency response resources identified within the representative area within a map. In some embodiments, the representative area is a regional agency, wherein the regional agency oversees a plurality of emergency network entities, each emergency network entity corresponding to a given geographic boundary. In some embodiments, the method further comprises: determining portions of emergency data corresponding to emergencies occurring within the plurality of emergency network entities' respective geographic boundary; and providing alert volume data within the regional view. wherein the alert volume corresponds to initiated emergency calls to the plurality of emergency network entities. In some embodiments, the one or more response elements comprises one or more emergency alerts or emergency response resources. In some embodiments, determining the representative area for emergency spatiotemporal analysis comprises receiving an emergency alert comprising an emergency location and generating a geospatial boundary around the emergency location. In some embodiments, generating the geospatial boundary around the emergency location comprises applying a radius around the emergency location. In some embodiments, the method further comprises expanding the geospatial boundary around the emergency location if no emergency alerts or emergency responses resources are identified within the geospatial boundary. In some embodiments, the method further comprises: automatically accessing one or more geofences associated with one or more emergency service providers (ESPs) from a geofence database, the one or more geofences comprising a first geofence associated with the ESP; determining that the emergency location is within the geofence associated with the ESP; and transmitting the one or more emergency alerts or emergency response resources identified within the representative area to the ESP in response to determining that the emergency location is within the geofence associated with the ESP. In some embodiments, determining the representative area for emergency spatiotemporal analysis comprises receiving an emergency data request comprising a geospatial boundary from the ESP. In some embodiments, the emergency data request is submitted through a graphical user interface (GUI) of an emergency response application. In some embodiments, the geospatial boundary is defined by a user of the emergency response application within an interactive map presented within the GUI. In some embodiments, the emergency data request is transmitted in response to the geospatial boundary being defined within the interactive map. In some embodiments, determining the representative area for emergency spatiotemporal analysis comprises receiving an emergency data request from the ESP comprising an identifier of the ESP and retrieving a geofence associated with the ESP using the identifier of the ESP. In some embodiments, the emergency data request is submitted through a graphical user interface (GUI) of an emergency response application. In some embodiments, the one or more emergency response elements identified within the representative area include one or more recent emergency alerts. In some embodiments, the one or more emergency response elements identified within the representative area include one or more historical emergency alerts. In some embodiments, the one or more emergency response elements identified within the representative area include one or more first responder locations. In some embodiments, the one or more emergency response elements identified within the representative area include one or more emergency response assets. In some embodiments, the one or more emergency response elements identified within the representative area comprises a first emergency alert, and the method further comprises: determining a common location associated with the first emergency alert; and transmitting the common location associated with the first emergency alert to the ESP. In some embodiments, the common location associated with the first emergency alert is determined and transmitted to the ESP in response to receiving selection of the first emergency alert by the ESP within a graphical user interface (GUI) of an emergency response application.

In another aspect, disclosed herein is a system comprising a processor and non-transitory computer readable storage medium including instructions that, when executed by the processor, causes the processor to: a) determine a representative area for emergency spatiotemporal analysis; b) identify one or more emergency response resources within the representative area; c) transmit the one or more emergency alerts or emergency response resources identified within the representative area to an emergency service provider (ESP); and d) display the one or more emergency alerts or emergency response resources identified within the representative area within a map. In some embodiments, the one or more response elements comprises one or more emergency alerts or emergency response resources. In some embodiments, determine the representative area for emergency spatiotemporal analysis comprises receiving an emergency alert comprising an emergency location and generating a geospatial boundary around the emergency location. In some embodiments, generate the geospatial boundary around the emergency location comprises applying a radius around the emergency location. In some embodiments, the processor is further caused to expand the geospatial boundary around the emergency location if no emergency alerts or emergency responses resources are identified within the geospatial boundary. In some embodiments, the processor is further caused to: a) automatically access one or more geofences associated with one or more emergency service providers (ESPs) from a geofence database, the one or more geofences comprising a first geofence associated with the ESP; b) determine that the emergency location is within the geofence associated with the ESP; and c) transmit the one or more emergency alerts or emergency response resources identified within the representative area to the ESP in response to determining that the emergency location is within the geofence associated with the ESP. In some embodiments, determine the representative area for emergency spatiotemporal analysis comprises receiving an emergency data request comprising a geospatial boundary from the ESP. In some embodiments, the emergency data request is submitted through a graphical user interface (GUI) of an emergency response application. In some embodiments, the geospatial boundary is defined by a user of the emergency response application within an interactive map presented within the GUI. In some embodiments, the emergency data request is transmitted in response to the geospatial boundary being defined within the interactive map. In some embodiments, determine the representative area for emergency spatiotemporal analysis comprises receiving an emergency data request from the ESP comprising an identifier of the ESP and retrieving a geofence associated with the ESP using the identifier of the ESP. In some embodiments, the emergency data request is submitted through a graphical user interface (GUI) of an emergency response application. In some embodiments, the one or more emergency response resources identified within the representative area include one or more recent emergency alerts. In some embodiments, the one or more emergency response resources identified within the representative area include one or more historical emergency alerts. In some embodiments, the one or more emergency response resources identified within the representative area include one or more first responder locations. In some embodiments, the one or more emergency response resources identified within the representative area include one or more emergency response assets. In some embodiments, the one or more emergency response resources identified within the representative area comprises a first emergency alert and wherein the processor is further caused to: a) determine a common location associated with the first emergency alert; and b) transmit the common location associated with the first emergency alert to the ESP. In some embodiments, the common location associated with the first emergency alert is determined and transmitted to the ESP in response to receiving selection of the first emergency alert by the ESP within a graphical user interface (GUI) of an emergency response application.

In another aspect, disclosed herein is a non-transitory computer readable storage medium including instructions that, when executed by a processor, causes the processor to: a) determine a representative area for emergency spatiotemporal analysis; b) identify one or more emergency response elements within the representative area; c) transmit the one or more emergency alerts or emergency response elements identified within the representative area to an emergency service provider (ESP); and d) display the one or more emergency alerts or emergency response elements identified within the representative area within a map. In some embodiments, the one or more response elements comprises one or more emergency alerts or emergency response resources. In some embodiments, determine the representative area for emergency spatiotemporal analysis comprises receiving an emergency alert comprising an emergency location and generating a geospatial boundary around the emergency location. In some embodiments, generate the geospatial boundary around the emergency location comprises applying a radius around the emergency location. In some embodiments, the processor is further caused to expand the geospatial boundary around the emergency location if no emergency alerts or emergency responses elements are identified within the geospatial boundary. In some embodiments, the processor is further caused to: a) automatically access one or more geofences associated with one or more emergency service providers (ESPs) from a geofence database, the one or more geofences comprising a first geofence associated with the ESP; b) determine that the emergency location is within the geofence associated with the ESP; and c) transmit the one or more emergency alerts or emergency response elements identified within the representative area to the ESP in response to determining that the emergency location is within the geofence associated with the ESP. In some embodiments, determine the representative area for emergency spatiotemporal analysis comprises receiving an emergency data request comprising a geospatial boundary from the ESP. In some embodiments, the emergency data request is submitted through a graphical user interface (GUI) of an emergency response application. In some embodiments, the geospatial boundary is defined by a user of the emergency response application within an interactive map presented within the GUI. In some embodiments, the emergency data request is transmitted in response to the geospatial boundary being defined within the interactive map. In some embodiments, determine the representative area for emergency spatiotemporal analysis comprises receiving an emergency data request from the ESP comprising an identifier of the ESP and retrieving a geofence associated with the ESP using the identifier of the ESP. In some embodiments, the emergency data request is submitted through a graphical user interface (GUI) of an emergency response application. In some embodiments, the one or more emergency response resources identified within the representative area include one or more recent emergency alerts. In some embodiments, the one or more emergency response resources identified within the representative area include one or more historical emergency alerts. In some embodiments, the one or more emergency response elements identified within the representative area include one or more first responder locations. In some embodiments, the one or more emergency response resources identified within the representative area include one or more emergency response assets. In some embodiments, the one or more emergency response resources identified within the representative area comprises a first emergency alert and wherein the processor is further caused to: a) determine a common location associated with the first emergency alert; and b) transmit the common location associated with the first emergency alert to the ESP. In some embodiments, the common location associated with the first emergency alert is determined and transmitted to the ESP in response to receiving selection of the first emergency alert by the ESP within a graphical user interface (GUI) of an emergency response application.

In another aspect, disclosed herein is a method for providing emergency assistance, the method comprising: a) receiving an emergency data request comprising an indicator of a representative area for spatiotemporal analysis from an emergency service provider (ESP); b) determining the representative area associated with the indicator; c) identifying one or more emergency response elements (e.g., emergency response resources) within the representative area; d) transmitting the one or more emergency alerts or emergency response elements identified within the representative area to the ESP; and e) displaying the one or more emergency alerts or emergency response elements identified within the representative area within a map. In some embodiments, the indicator of the representative area is an identifier of the ESP and wherein determining the representative area associated with the indicator comprises retrieving a geofence associated with the ESP using the identifier of the ESP. In some embodiments, the indicator of the representative area is a geospatial boundary and wherein determining the representative area associated with the indicator comprises rastering the geospatial boundary. In some embodiments, the emergency data request is submitted through a graphical user interface (GUI) of an emergency response application. In some embodiments, the geospatial boundary is defined by a user of the emergency response application within an interactive map presented within the GUI. In some embodiments, the emergency data request is transmitted in response to the geospatial boundary being defined within the interactive map. In some embodiments, the indicator of the representative area is an emergency location and wherein determining the representative area associated with the indicator comprises generating a geospatial boundary around the emergency location.

In another aspect, disclosed herein is a system comprising a processor and non-transitory computer readable storage medium including instructions that, when executed by the processor, causes the processor to: a) receive an emergency data request comprising an indicator of a representative area for spatiotemporal analysis from an emergency service provider (ESP); b) determine the representative area associated with the indicator; c) identify one or more emergency response elements within the representative area; d) transmit the one or more emergency alerts or emergency response elements identified within the representative area to the ESP; and e) display the one or more emergency alerts or emergency response elements identified within the representative area within a map. In some embodiments, the indicator of the representative area is an identifier of the ESP and wherein determining the representative area associated with the indicator comprises retrieving a geofence associated with the ESP using the identifier of the ESP. In some embodiments, the indicator of the representative area is a geospatial boundary and wherein determining the representative area associated with the indicator comprises rastering the geospatial boundary. In some embodiments, the emergency data request is submitted through a graphical user interface (GUI) of an emergency response application. In some embodiments, the geospatial boundary is defined by a user of the emergency response application within an interactive map presented within the GUI. In some embodiments, the emergency data request is transmitted in response to the geospatial boundary being defined within the interactive map. In some embodiments, the indicator of the representative area is an emergency location and wherein determine the representative area associated with the indicator comprises generating a geospatial boundary around the emergency location.

In another aspect, disclosed herein is a non-transitory computer readable storage medium including instructions that, when executed by a processor, causes the processor to: a) receive an emergency data request comprising an indicator of a representative area for spatiotemporal analysis from an emergency service provider (ESP); b) determine the representative area associated with the indicator; c) identify one or more emergency response resources within the representative area; d) transmit the one or more emergency alerts or emergency response resources identified within the representative area to the ESP; and e) display the one or more emergency alerts or emergency response resources identified within the representative area within a map. In some embodiments, the indicator of the representative area is an identifier of the ESP and wherein determining the representative area associated with the indicator comprises retrieving a geofence associated with the ESP using the identifier of the ESP. In some embodiments, the indicator of the representative area is a geospatial boundary and wherein determining the representative area associated with the indicator comprises rastering the geospatial boundary. In some embodiments, the emergency data request is submitted through a graphical user interface (GUI) of an emergency response application. In some embodiments, the geospatial boundary is defined by a user of the emergency response application within an interactive map presented within the GUI. In some embodiments, the emergency data request is transmitted in response to the geospatial boundary being defined within the interactive map. In some embodiments, the indicator of the representative area is an emergency location and wherein determine the representative area associated with the indicator comprises generating a geospatial boundary around the emergency location.

In another aspect, disclosed herein is a method for providing emergency assistance, the method comprising: a) receiving an emergency data request comprising a geofence from an emergency service provider (ESP); b) identifying one or more emergency response resources within the geofence; c) transmitting the one or more emergency response resources identified within the geofence to the ESP; and d) displaying the one or more emergency response resources identified within the geofence within a map.

In another aspect, disclosed herein is a system comprising a processor and non-transitory computer readable storage medium including instructions that, when executed by the processor, causes the processor to: a) receive an emergency data request comprising a geofence from an emergency service provider (ESP); b) identify one or more emergency response elements within the geofence; c) transmit the one or more emergency response elements identified within the geofence to the ESP; and d) display the one or more emergency response elements identified within the geofence within a map.

In another aspect, disclosed herein is a non-transitory computer readable storage medium including instructions that, when executed by a processor, causes the processor to: a) receive an emergency data request comprising a geofence from an emergency service provider (ESP); b) identify one or more emergency response elements within the geofence; c) transmit the one or more emergency response elements identified within the geofence to the ESP; and d) display the one or more emergency response elements identified within the geofence within a map.

In another aspect, disclosed herein is a method for providing emergency assistance, the method comprising: receiving an emergency alert from an electronic device; receiving information regarding one or more wireless signals within detectable range of the electronic device; determining a landmark location associated with the emergency alert at least using the information regarding the one or more wireless signals; and transmitting the landmark location associated with the emergency alert to a first emergency service provider (ESP) for display within a map. In some embodiments, the emergency alert received from the electronic device comprises the information regarding the one or more wireless signals. In some embodiments, the method further comprises transmitting a request for wireless signal information to the electronic device and wherein the information regarding the one or more signals is received within a response to the request for wireless signal information from the electronic device. In some embodiments, the information regarding the one or more wireless signals comprises identifiers of the one or more wireless signals and wherein determining the landmark location comprises querying a database of landmark locations with the identifiers of the one or more wireless signals. In some embodiments, determining the landmark location comprises deriving the landmark location from the information regarding the one or more wireless signals. In some embodiments, the information regarding the one or more wireless signals comprises identifiers of the one or more wireless signals and wherein the location landmark is derived from the identifiers of the one or more wireless signals. In some embodiments, the information regarding the one or more wireless signals comprises identifiers of the one or more wireless signals and wherein determining the landmark location comprises querying a source of the one or more wireless signals with the identifiers of the one or more wireless signals. In some embodiments, the method further comprises generating a confidence score for the landmark location using the information regarding the one or more wireless signals. In some embodiments, the method further comprises transmitting the confidence score for the landmark location to the first ESP in addition to the landmark location. In some embodiments, the emergency alert comprises an emergency location associated with the emergency alert, and the method further comprises: transmitting the emergency location associated with the emergency alert to the first ESP; determining if the confidence score for the landmark location is above a threshold confidence score; and transmitting the landmark location associated with the emergency alert to the first ESP if the confidence score is determined to be above the threshold score or forgoing transmitting the landmark location associated with the emergency alert to the first ESP if the confidence score is not determined to be above the threshold confidence score. In some embodiments, the emergency alert comprises an emergency location associated with the emergency alert. In some embodiments, the method further comprises transmitting the emergency location to the one or more emergency service providers in addition to the landmark location. In some embodiments, the method further comprises: automatically accessing one or more geofences associated with one or more emergency service providers (ESPs) from a geofence database, the one or more geofences comprising a first geofence associated with the first ESP; determining that the emergency location is within the geofence associated with the first ESP; and transmitting the landmark location associated with the emergency alert to the first ESP in response to determining that the emergency location is within the geofence associated with the first ESP. In some embodiments, the emergency alert comprises a device identifier associated with the emergency alert and further comprising: receiving an emergency data request comprising the device identifier associated with the emergency alert from the first ESP; and transmitting the location landmark associated with the emergency alert to the first ESP in response to receiving the emergency data request comprising the device identifier associated with the emergency alert from the first ESP. In some embodiments, the method further comprises: generating navigation instructions to the landmark location associated with the emergency alert; and transmitting the navigation instructions to the first ESP.

In another aspect, disclosed herein is a system comprising a processor and non-transitory computer readable storage medium including instructions that, when executed by the processor, causes the processor to: receive an emergency alert from an electronic device; receive information regarding one or more wireless signals within detectable range of the electronic device; determine a landmark location associated with the emergency alert at least using the information regarding the one or more wireless signals; and transmit the landmark location associated with the emergency alert to a first emergency service provider (ESP) for display within a map. In some embodiments, the emergency alert received from the electronic device comprises the information regarding the one or more wireless signals. In some embodiments, the processor is further caused to transmit a request for wireless signal information to the electronic device and wherein the information regarding the one or more signals is received within a response to the request for wireless signal information from the electronic device. In some embodiments, the information regarding the one or more wireless signals comprises identifiers of the one or more wireless signals and wherein determine the landmark location comprises querying a database of landmark locations with the identifiers of the one or more wireless signals. In some embodiments, determine the landmark location comprises deriving the landmark location from the information regarding the one or more wireless signals. In some embodiments, the information regarding the one or more wireless signals comprises identifiers of the one or more wireless signals and wherein the location landmark is derived from the identifiers of the one or more wireless signals. In some embodiments, the information regarding the one or more wireless signals comprises identifiers of the one or more wireless signals and wherein determine the landmark location comprises querying a source of the one or more wireless signals with the identifiers of the one or more wireless signals. In some embodiments, the processor is further caused to generate a confidence score for the landmark location using the information regarding the one or more wireless signals. In some embodiments, the processor is further caused to transmit the confidence score for the landmark location to the first ESP in addition to the landmark location. In some embodiments, the emergency alert comprises an emergency location associated with the emergency alert and wherein the processor is further caused to: transmit the emergency location associated with the emergency alert to the first ESP; determine if the confidence score for the landmark location is above a threshold confidence score; and transmit the landmark location associated with the emergency alert to the first ESP if the confidence score is determined to be above the threshold score or forgoing transmitting the landmark location associated with the emergency alert to the first ESP if the confidence score is not determined to be above the threshold confidence score. In some embodiments, the emergency alert comprises an emergency location associated with the emergency alert. In some embodiments, the processor is further caused to transmit the emergency location to the one or more emergency service providers in addition to the landmark location. In some embodiments, the processor is further caused to: automatically access one or more geofences associated with one or more emergency service providers (ESPs) from a geofence database, the one or more geofences comprising a first geofence associated with the first ESP; determine that the emergency location is within the geofence associated with the first ESP; and transmit the landmark location associated with the emergency alert to the first ESP in response to determining that the emergency location is within the geofence associated with the first ESP. In some embodiments, the emergency alert comprises a device identifier associated with the emergency alert and wherein the processor is further caused to: receive an emergency data request comprising the device identifier associated with the emergency alert from the first ESP; and transmit the location landmark associated with the emergency alert to the first ESP in response to receiving the emergency data request comprising the device identifier associated with the emergency alert from the first ESP. In some embodiments, the processor is further caused to: generate navigation instructions to the landmark location associated with the emergency alert; and transmit the navigation instructions to the first ESP.

In another aspect, disclosed herein is a non-transitory computer readable storage medium including instructions that, when executed by a processor, causes the processor to: a) receive an emergency alert from an electronic device; b) receive information regarding one or more wireless signals within detectable range of the electronic device; c) determine a landmark location associated with the emergency alert at least using the information regarding the one or more wireless signals; and d) transmit the landmark location associated with the emergency alert to a first emergency service provider (ESP) for display within a map. In some embodiments, the emergency alert received from the electronic device comprises the information regarding the one or more wireless signals. In some embodiments, the processor is further caused to transmit a request for wireless signal information to the electronic device and wherein the information regarding the one or more signals is received within a response to the request for wireless signal information from the electronic device. In some embodiments, the information regarding the one or more wireless signals comprises identifiers of the one or more wireless signals and wherein determine the landmark location comprises querying a database of landmark locations with the identifiers of the one or more wireless signals. In some embodiments, determine the landmark location comprises deriving the landmark location from the information regarding the one or more wireless signals. In some embodiments, the information regarding the one or more wireless signals comprises identifiers of the one or more wireless signals and wherein the location landmark is derived from the identifiers of the one or more wireless signals. In some embodiments, the information regarding the one or more wireless signals comprises identifiers of the one or more wireless signals and wherein determine the landmark location comprises querying a source of the one or more wireless signals with the identifiers of the one or more wireless signals. In some embodiments, the processor is further caused to generate a confidence score for the landmark location using the information regarding the one or more wireless signals. In some embodiments, the processor is further caused to transmit the confidence score for the landmark location to the first ESP in addition to the landmark location. In some embodiments, the emergency alert comprises an emergency location associated with the emergency alert and wherein the processor is further caused to: a) transmit the emergency location associated with the emergency alert to the first ESP; b) determine if the confidence score for the landmark location is above a threshold confidence score; and c) transmit the landmark location associated with the emergency alert to the first ESP if the confidence score is determined to be above the threshold score or forgoing transmitting the landmark location associated with the emergency alert to the first ESP if the confidence score is not determined to be above the threshold confidence score. In some embodiments, the emergency alert comprises an emergency location associated with the emergency alert. In some embodiments, the processor is further caused to transmit the emergency location to the one or more emergency service providers in addition to the landmark location. In some embodiments, the processor is further caused to: a) automatically access one or more geofences associated with one or more emergency service providers (ESPs) from a geofence database, the one or more geofences comprising a first geofence associated with the first ESP; b) determine that the emergency location is within the geofence associated with the first ESP; and c) transmit the landmark location associated with the emergency alert to the first ESP in response to determining that the emergency location is within the geofence associated with the first ESP. In some embodiments, the emergency alert comprises a device identifier associated with the emergency alert and wherein the processor is further caused to: a) receive an emergency data request comprising the device identifier associated with the emergency alert from the first ESP; and b) transmit the location landmark associated with the emergency alert to the first ESP in response to receiving the emergency data request comprising the device identifier associated with the emergency alert from the first ESP. In some embodiments, the processor is further caused to: a) generate navigation instructions to the landmark location associated with the emergency alert; and b) transmit the navigation instructions to the first ESP.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A depicts diagrams of (i) an electronic device and (ii) an emergency management system (EMS) in accordance with one embodiment of the present disclosure;

FIG. 1B depicts diagrams of (iii) an emergency service provider (ESP) system and (iv) ESP software in accordance with one embodiment of the present disclosure;

FIG. 2 depicts a diagram of a clearinghouse for emergency data in accordance with one embodiment of the present disclosure;

FIG. 3 depicts a diagram of a geofence system applied to a clearinghouse for emergency data in accordance with one embodiment of the present disclosure;

FIG. 4 illustrates a map of non-limiting examples of geofence approximations in accordance with one embodiment of the present disclosure;

FIG. 5 illustrates an example of a graphical user interface (GUI) of an emergency response application in accordance with one embodiment of the present disclosure;

FIG. 6 depicts a flow diagram of methods for providing emergency assistance by an emergency management system (EMS) in accordance with some embodiments of the present disclosure;

FIG. 7 illustrates non-limiting examples of emergency spatiotemporal analyses in accordance with one embodiment of the present disclosure;

FIG. 8 illustrates an example of a process for determining if an emergency response asset is available for an emergency location in accordance with one embodiment of the present disclosure;

FIG. 9 illustrates an example of a process for determining if an emergency response asset is available for an emergency location in accordance with one embodiment of the present disclosure;

FIG. 10 illustrates a process for determining a landmark location in accordance with embodiment of the present disclosure;

FIG. 11 illustrates an example of emergency data geofencing in accordance with one embodiment of the present disclosure;

FIG. 12 illustrates processes for submitting an emergency data request through an emergency response application in accordance with some embodiment of the present disclosure;

FIG. 13A illustrates an example of a graphical user interface (GUI) of an emergency response application in accordance with one embodiment of the present disclosure;

FIG. 13B illustrates an example of a graphical user interface (GUI) of an emergency response application in accordance with one embodiment of the present disclosure;

FIG. 14A illustrates an example of a graphical user interface (GUI) of emergency metrics for a regional agency; and

FIG. 14B illustrates an example of a graphical user interface (GUI) of emergency metrics for an ESP agency.

### DETAILED DESCRIPTION

Disclosed herein are systems, devices, media, and methods for providing enhanced emergency communications and functions. Embodiments of the present disclosure take advantage of technological advancements that have allowed for mobile communication devices to generate accurate locations by incorporating multiple technologies embedded in the devices, such as GPS, Wi-Fi, and Bluetooth to create device-based hybrid locations. Device-based hybrid locations are locations calculated on an electronic or communication device, as opposed to locations calculated using a network (e.g., a carrier network). Device-based hybrid locations can be generated using GPS, network-based technologies, Wi-Fi access points, Bluetooth beacons, barometric pressure sensors, dead reckoning using accelerometers and gyrometers, and a variety of crowdsourced and proprietary databases that device operating systems providers are running to enhance location technology. These device-based hybrid locations can be quickly generated during emergency calls. Additionally, recently developed smart systems and devices such as internet-enabled automated external defibrillators (hereinafter, “smart AEDs”) or unmanned aerial vehicles (UAVs; e.g., drones) have allowed for new modes of providing emergency response.

Furthermore, mobile communication devices (e.g., mobile phones, wearables, IoT devices, smart home devices, vehicle computers, etc.) are often capable of generating or storing additional information that may be useful in responding to emergency situations, such as health data or medical histories. For example, during an emergency, a modern mobile communication device may have access to an implicated person's blood type, preexisting medical conditions, or even the implicated person's current heartrate. In some embodiments, the mobile communication device has access to data from sensors (e.g., health or environmental sensors). For example, a video feed of the emergency via a connected surveillance camera can provide valuable situational awareness regarding the emergency.

### Electronic Device, Emergency Management System (EMS), and Emergency Service Provider (ESP)

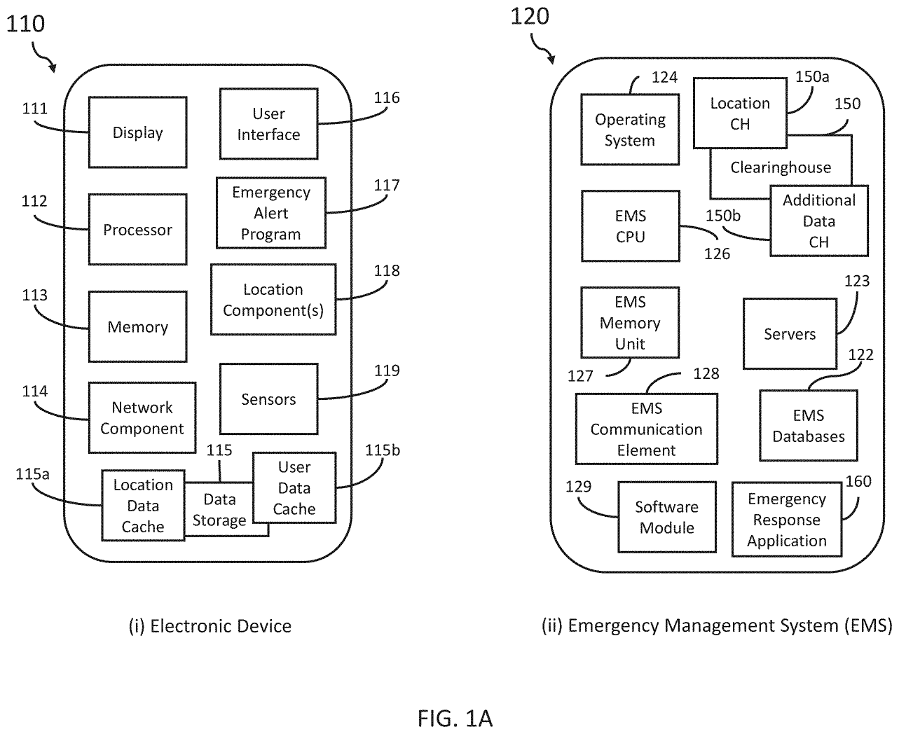

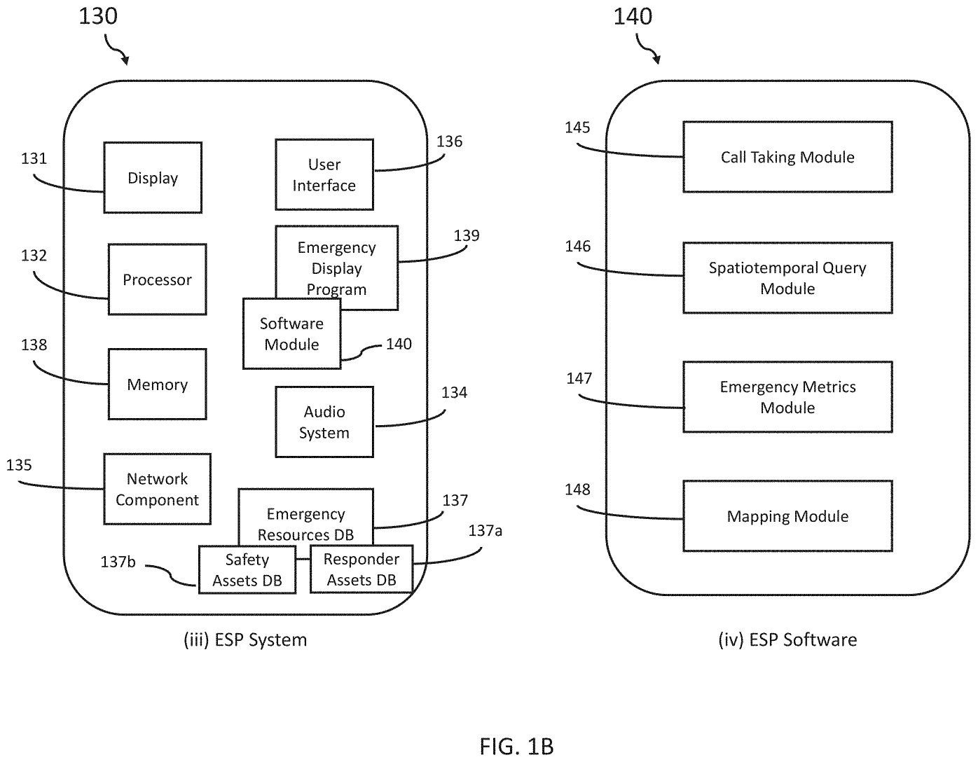

In various embodiments, disclosed herein are devices, systems, and methods for managing emergency data for emergency response. FIG. 1A depicts diagrams of (i) an electronic device 110 and (ii) an emergency management system (EMS) 120 in accordance with one embodiment of the present invention. In some embodiments, the electronic device 110 is a digital processing device such as a communication device (e.g., mobile or cellular phone, computer, laptop, etc.). In some embodiments, the electronic device is a wearable device (e.g., a smartwatch). In some embodiments, the electronic device is an Internet of Things (IoT) device, such as a home assistant (e.g., an Amazon Echo) or a connected smoke detector (e.g., a Nest Protect smoke and carbon monoxide alarm). In some embodiments, the electronic device is a walkie-talkie or two-way radio.

In some embodiments, the electronic device 110 includes a display 111, a processor 112, a memory 113 (e.g., an EPROM memory, a RAM, or a solid-state memory), a network component 114 (e.g., an antenna and associated components, Wi-Fi adapters, Bluetooth adapters, etc.), a data storage 115, a user interface 116, an emergency alert program 117, one or more location components 118, and one or more sensors 119. In some embodiments, the processor 112 is implemented as one or more microprocessors, microcomputers, microcontrollers, digital signal processors, central processing units, state machines, logic circuitries, and/or devices that manipulate signals based on operational instructions. Among other capabilities, the processor 112 is configured to fetch and execute computer-readable instructions stored in the memory 113.

In some embodiments, the display 111 is part of the user interface 116 (e.g., a touchscreen is both a display and a user interface in that it provides an interface to receive user input or user interactions). In some embodiments, the user interface 116 includes physical buttons such as an on/off button or volume buttons. In some embodiments, the display 111 and/or the user interface 116 comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage 115 includes a location data cache 115A and a user data cache 115B. In some embodiments, the location data cache 115A is configured to store locations generated by the one or more location components 118.

In some embodiments, the emergency alert program 117 is an emergency response application or emergency response mobile application. In some embodiments, the emergency alert program 117 is configured to record user data, such as a name, address, or medical data of a user associated with the electronic device 110. In some embodiments, the emergency alert program 117 is configured to detect when an emergency request is generated or sent by the electronic device 110 (e.g., when a user uses the electronic device 110 to make an emergency call). In some embodiments, in response to detecting an emergency request generated or sent by the electronic device 110, the emergency alert program 117 is configured to deliver a notification to the EMS 120. In some embodiments, the notification is an HTTP post containing information regarding the emergency request. In some embodiments, the notification includes a location (e.g., a device-based hybrid location) generated by or for the electronic device 110. In some embodiments, in response to detecting an emergency request generated or sent by the electronic device 110, the emergency alert program 117 is configured to deliver user data to the EMS 120.

In some embodiments, as depicted in FIG. 1A, the emergency management system (EMS) 120 includes an EMS operating system 124, an EMS CPU 126, an EMS memory unit 127, an EMS communication element 128, and one or more software modules 129. In some embodiments, the EMS CPU 126 is implemented as one or more microprocessors, microcomputers, microcontrollers, digital signal processors, central processing units, state machines, logic circuitries, and/or devices that manipulate signals based on operational instructions. Among other capabilities, the EMS CPU 126 is configured to fetch and execute computer-readable instructions stored in the EMS memory unit 127. The EMS memory unit 127 optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The EMS memory unit 127 optionally includes modules, routines, programs, objects, components, data structures, etc., which perform particular tasks or implement particular abstract data types.

In some embodiments, the EMS 120 includes one or more EMS databases 122, one or more servers 123, and a clearinghouse 150. In some embodiments, the clearinghouse 150, as described in further detail below, is an input/output (I/O) interface configured to manage communications and data transfers to and from the EMS 120 and external systems and devices. In some embodiments, the clearinghouse 150 includes a variety of software and hardware interfaces, for example, a web interface, a graphical user interface (GUI), and the like. The clearinghouse 150 optionally enables the EMS 120 to communicate with other computing devices, such as web servers and external data servers (not shown). In some embodiments, the clearinghouse 150 facilitates multiple communications within a wide variety of networks and protocol types, including wired networks, for example, LAN, cable, etc., and wireless networks, such as WLAN, cellular, or satellite. In some embodiments, the clearinghouse 150 includes one or more ports for connecting a number of devices to one another or to another server. In some embodiments, the clearinghouse 150 includes one or more sub-clearinghouses, such as location clearinghouse 150A and additional data clearinghouse 150B, configured to manage the transfer of locations and additional data, respectively. In some embodiments, the EMS 120 additionally includes a user information module 161 that receives and stores user information (e.g., personal information, demographic information, medical information, location information, etc.) within the EMS 120. In some embodiments, users can submit user information through a website, web application, or mobile application, such as during a registration process for an emergency response application. In some embodiments, when the EMS 120 receives emergency data including user information, such as through an emergency alert received by the clearinghouse 150 (as described below), the EMS 120 stores the user information in the user information module 161. In some embodiments, user information stored within the user information module 161 is received by the EMS 120 from a third-party server system, as described below. In some embodiments, user information stored within the user information module 161 is associated with an identifier of a user or an electronic device associated with a user, such as a phone number or an email address.

In some embodiments, as depicted in FIG. 1B, an emergency service provider (ESP, e.g., a public safety answering point (PSAP)) system 130 includes one or more of a display 131, a user interface 136, at least one central processing unit or processor 132, a network component 135, an audio system 134 (e.g., microphone, speaker and/or a call-taking headset), and a computer program such as an Emergency Display Program 139. In some embodiments, Emergency Display program 139 comprises one or more software modules 140. In some embodiments, the PSAP system 130 comprises a database of emergency resources 137, such as medical assets, police assets, fire response assets, rescue assets, safety assets, etc. In some embodiments, the emergency resources database 137 includes two or more separate databases, such as responder assets DB for responder locations, facilities, vehicles, etc. 137a and safety assets DB for assets that can be used for emergency response 137b. Safety assets may be helpful for emergency responses such as cameras, Iot devices, door locks, fire extinguishers, fire hydrants, AEDs, eye wash stations, first-aid kits, etc.

In some embodiments, as depicted in FIG. 1B, the ESP software 139 installed on an ESP system 130 (e.g., a PSAP agency) comprising a software module 140 is a call taking module 145, a spatiotemporal query module 146, an emergency metrics module 147, or a combination thereof. In some embodiments, the ESP software 139 displays the information on a map (e.g., on the display 131). In some embodiments, location and supplemental information is displayed for emergency service providers (e.g., police, fire, medical, etc.) and/or responders on their devices. It is contemplated that responder devices have optionally installed a responder device program (not shown) similar to PSAP display module 146. In some embodiments, the responder device program displays the emergency location on a map.

### Emergency Clearinghouse

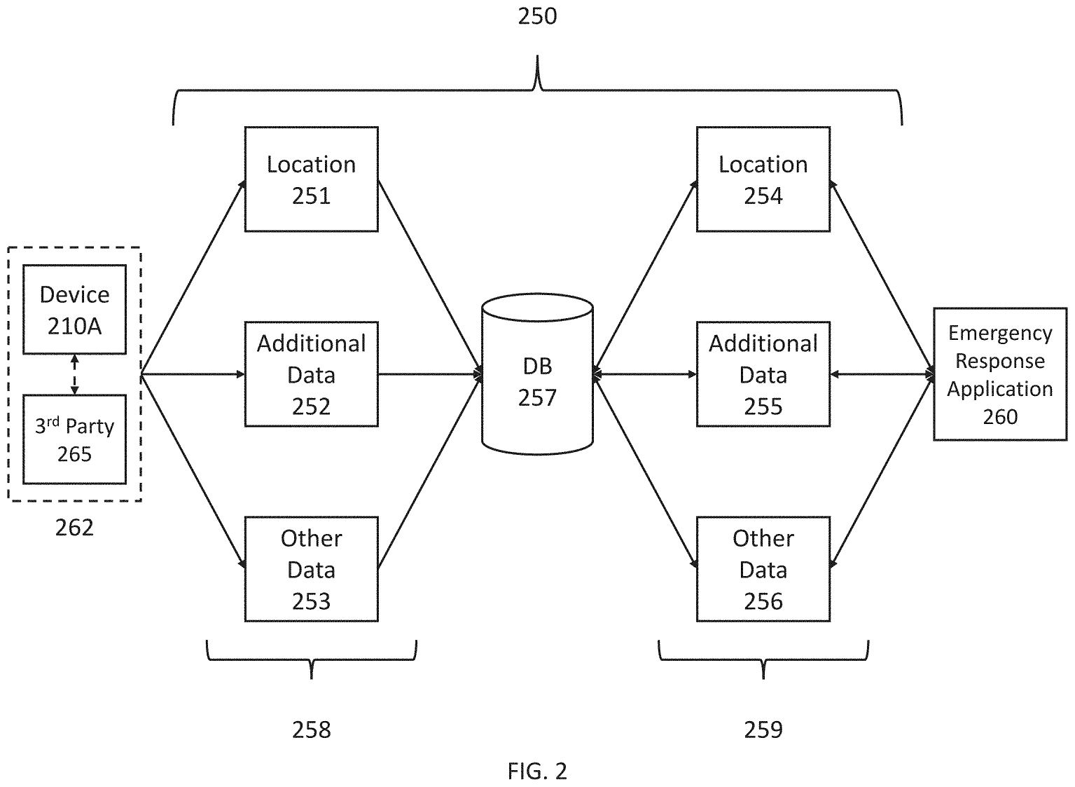

In some embodiments, as mentioned above with respect to FIG. 1A, the emergency management system (EMS) 120 includes a clearinghouse 150 (also referred to as an “Emergency Clearinghouse”) for storing, retrieving, and transmitting emergency data. In some embodiments, the clearinghouse 150 includes a location clearinghouse 150A and an additional data clearinghouse 150B. In some embodiments, the location clearinghouse 150A includes a location ingestion module and a location retrieval module, as described below with respect to FIG. 2. In some embodiments, the additional data clearinghouse 150B includes an additional data ingestion module and an additional data retrieval module, as described below with respect to FIG. 2. In other embodiments, additional data and location data (hereinafter “emergency data”) are stored in one or more databases in a distributed manner. In some embodiments, the emergency data is stored in an external or third-party server that is accessible to the EMS 120. The clearinghouse 150 optionally functions as an interface that receives and stores emergency data from electronic or communication devices that are then retrieved, transmitted, and/or distributed to recipients (e.g., emergency service providers) before, during, or after emergencies. As described above, the clearinghouse optionally receives emergency data from electronic or communication devices such as mobile phones, wearable devices, laptop or desktop computers, personal assistants, intelligent vehicle systems, home security systems, IoT devices, camera feeds, and other sources (e.g., emergency response assets and asset service providers, as described in further detail below). As described above and below, emergency data optionally includes locations or additional data such as medical history, personal information, or contact information. In some embodiments, during an emergency, the clearinghouse 150 detects the emergency and/or otherwise identifies the need to provide emergency data pertaining to the emergency. The clearinghouse 150 then identifies any emergency data pertaining to the emergency stored within the clearinghouse 150 and transmits the pertinent emergency data to the requesting ESP. Accordingly, in some embodiments, the clearinghouse 150 acts as a data pipeline that automatically pushes emergency data to an ESP that would otherwise be without access to emergency data that is critical to most effectively and efficiently responding to an emergency. Accordingly, location data stored within the clearinghouse 150 allows emergency responders to arrive at the scene of an emergency faster, and additional data stored within the clearinghouse 150 allows emergency responders to be better prepared for the emergencies they face.

For example, in one embodiment, an emergency alert is triggered by an electronic device 110 (e.g., by pressing a soft button, a physical button, voice command, or gesture) or autonomously based on sensor data (e.g., smoke alarms). In this example, the user then confirms the emergency and/or provides authorization for sending the emergency alert. Emergency data, such as an enhanced location and additional data regarding the user (e.g., the user's medical history) is delivered by the electronic device 110 to the EMS 120 and stored in the clearinghouse 150 (e.g., in the location clearinghouse 150A and the additional data clearinghouse 150B). In some embodiments, the EMS 120 or clearinghouse 150 formats the emergency data into a format that is compatible with industry standards for storing and sharing emergency data. For example, in some embodiments, the emergency data is formatted to be compatible with National Emergency Number Association (NENA) standards. In some embodiments, the clearinghouse 150 transmits the emergency data to a receiving party in response to receiving a query from the receiving party, as described below. In some embodiments, the clearinghouse 150 automatically pushes the emergency data to a receiving party (e.g., without receiving a query from the receiving party), such as a PSAP. For example, in some embodiments, the clearinghouse 150 or emergency management system 120 housing the clearinghouse automatically pushes the emergency data to a receiving party using a subscription system, as described below.

In some embodiments, as mentioned above, a requesting party (such as a PSAP responding to an emergency call) queries the clearinghouse 150 with an emergency data request (such as a HTTP GET request). In some embodiments, the emergency data request is in the form of the Location Information Server (LIS) protocol. In response to the emergency data request, the EMS 120 or clearinghouse 150 sends an appropriate response including relevant emergency data to the requesting party via an encrypted pathway. In some embodiments, the emergency data request is in the form of HTTP-Enabled Location Delivery (HELD) and the response from the EMS 120 or clearinghouse 150 is in the form of Presence Information Data Format Location Object (PIDF-LO). In some embodiments, the emergency data request includes an authorization code (also referred to as an “authorization token” or “temporary access token”) in the body, header, or metadata of the request, and the EMS 120 checks that the authorization code is active before providing a response to the requesting party. In some embodiments, authorization is provided in the “Authorization” header of the emergency data request using HTTP Basic Authentication. For example, in some embodiments, authorization is base64-encoded username and password for an account associated with the requesting party. In some embodiments, emergency data requests are sent over public networks using API access keys or credentials. In some embodiments, Transport Layer Security (TLS) is used in the requests and responses from the EMS 120 for encryption security. In some embodiments, the call taking module 145 includes a call-handling application, which is provided by a third-party vendor. In some embodiments, an ESP personnel interacts with the call-handling application to send an emergency data request to the EMS 120. In some embodiments, the response from the EMS 120 is displayed at the ESP display 131.

In some embodiments, as described above, emergency data includes locations and additional data. In some embodiments, emergency data includes one or more emergency data categories (also referred to as “data categories”). In some embodiments, the emergency data categories include service data reference, full name, email, emergency contacts, addresses, language, occupation, phone numbers, websites, gender, height, weight, ethnicity, profile picture, allergies, medical conditions, medications, disabilities, blood type, medical notes, birthday, and additional comments. In some embodiments, emergency data categories are tagged with tags for specific types of data such as “demographics” or “medical data.” For example, in some embodiments, gender, height, weight, ethnicity, profile picture (image-url) are tagged as demographic data. In some embodiments, medical data protected under HIPAA and other laws are tagged as “HIPAA” or “private.” In some embodiments, medical data includes information on one or more of allergies, medical condition(s) or illness(es), medication(s), disabilities, blood type, medical note(s), and other medical information. In some embodiments, medical information protected under HIPAA are encrypted and/or anonymized. In some embodiments, some data are tagged as “general” or another similar tag, wherein access is not specifically restricted.

An example of an additional data communication from the EMS 120 in a standard format compatible with industry standards, PIDF-LO, is shown below.
HTTP/1.1 200 OK
Date: Tue, 01 Dec 2016 23:27:30 GMT
Content-Length: 489
Content-Type: application/EmergencyCallData.DeviceInfo+xml
<dev:EmergencyCallData.DeviceInfo
xmlns:dev=“urn:ietfparams:xml:ns:EmergencyCallData:DeviceInfo”>
<dev:DataProviderReference>d4b3072df.201409182208075@example.org

In some embodiments, when the emergency data is stored at a third-party server and receives a request for emergency data from the EMS 120, as a database query, the third-party server formats the requested emergency data and stores this information in an alternate database, and forwards either a response or a reference to the alternate database for accessing the emergency data requested by the EMS 120, which is provided to the ESP 130 over a hybrid analog and/or a data communication channel, depending on the capabilities of ESP 130. In some embodiments, the third-party server stores the emergency data, requested by the EMS 120 or directly by the ESP 130, in the alternate database for a certain period of time after receiving the request for the emergency data regarding a user and any electronic devices 110. In some embodiments, this period of time is a timer value (e.g., a timer countdown or a set time point) defined by the EMS 120 and the third-party server in conjunction with each other prior to the addition of the requested emergency data to the alternate database at the third-party server. In some embodiments, once the timer value has passed and no new requests for the emergency data pertaining to the particular user and the electronic device 110, or other devices associated with the user, are received by the third-party server, then the third-party server marks the particular alternate database entries to be deleted and waits for another, different, time-out interval. In some embodiments, once this particular second time-out interval has also been completed and no new requests for location data for the particular user or associated electronic devices 110 are received by the third-party server, the third-party server removes the specific marked entries from the alternate database in the next cycle of updates for the alternate database. In some embodiments, after adding the emergency data in the alternate database by the third-party server, the third-party server keeps updating the emergency data in the alternate database on a periodic, or as-needed basis, for the purpose of keeping the emergency data about the user or electronic device 110 current for providing the most recent and accurate emergency data to the EMS 120 and the ESP 130 for the purposes of responding to a request for emergency assistance. In some embodiments, the third-party server is updated by the EMS 120 for all the emergency data pertaining to all users and their associated electronic devices 110 that are served by the EMS 120 at any current time.

In some non-emergency situations, there is a need to access location data, user data, emergency data or sensor data. For example, in some embodiments, a user of an electronic device 110 grants authorization to family members to access location data for the user. Accordingly, when a family member requests location data for a user, access is granted if there is proper authorization. As another example, in some embodiments, a taxi operations company requests and obtains location data of one or more fleet members to keep track of its vehicles (e.g., via onboard vehicle console or terminal).

Various embodiments and applications of the clearinghouse 150 are described in detail herein. However, the embodiments and applications described herein should not be considered exhaustive or limiting in any way.

FIG. 2 depicts an embodiment of an Emergency Clearinghouse 250 for storing and retrieving emergency data. In some embodiments, the clearinghouse 250 includes a set of ingestion modules 258 (also referred to as “ingestion modules”) and a set of retrieval modules 259 (also referred to as “retrieval modules”). The set of ingestion modules 258 is configured to receive various forms of emergency data from various emergency data sources 262, such as an electronic device 210A or a third-party server system 265 (hereinafter, “third-party server”). In some embodiments, an electronic device 210A is a communication device (e.g., a mobile phone), a wearable device (e.g., a smartwatch), or an internet of things (IoT) device (e.g., a smart speaker) that can communicate with one or more of the ingestion modules within the set of ingestion modules 258. In some embodiments, a third-party server 265 stores data that is not generated by or stored within an electronic device. For example, in some embodiments, a third-party server includes a database of static medical information that can be sent to the clearinghouse during an emergency. In some embodiments, when the emergency management system 120 detects an emergency (e.g., when a person calls 9-1-1), the clearinghouse 250 can query an emergency data source 262 for emergency data regarding the emergency. For example, in some embodiments, in response to detecting a 9-1-1 call made from a mobile phone, the additional data ingestion module 252 (as described below) sends a query including the phone number of the mobile phone to a third-party server 265 that stores static medical information. The third-party server 265 can then return any available medical information associated with the phone number of the mobile phone to the additional data ingestion module. In some embodiments, multiple ingestion modules within the set of ingestion modules can receive emergency data for a single emergency. For example, in some embodiments, when a person calls 9-1-1 from a mobile phone, the mobile phone can send a device-based hybrid location to the location ingestion module 251 (as described below) and demographic data (as described above) to the additional data ingestion module 252. In some embodiments, the clearinghouse can receive emergency data from multiple emergency data sources 262 for a single emergency. For example, in some embodiments, when a person calls 9-1-1 from a mobile phone, the clearinghouse can receive a location from the mobile phone (such as through the location ingestion module 251) and a heartrate from a smartwatch that the person is wearing (such as through additional data ingestion module 252). Or for example, in some embodiments, when a person calls 9-1-1 from a mobile phone, the clearinghouse can receive a location from the mobile phone and medical information associated with the person from a third-party server 265.

The set of ingestion modules 258 optionally include a location ingestion module 251, an additional data ingestion module 252, and one or more other data ingestion modules 253. In some embodiments, the location ingestion module 251 is an emergency location service ingestion interface for posting or receiving emergency locations. In some embodiments, the location ingestion module 251 is a REST API that receives an HTTP POST including location data when an emergency alert is generated (e.g., when an emergency call is made from a cell phone). The location data includes a location generated concurrently or in response to the generation of the emergency alert. In some embodiments, the location data includes a location generated before the emergency alert. For example, when an emergency call is made from a cell phone, thereby generating an emergency alert, the location ingestion module 251 receives a location recently generated by the phone but before the emergency alert was generated, ensuring that a location for the emergency is available as quickly as possible. In some embodiments, the location data includes a device-based hybrid location generated by an electronic device 210 that generated the emergency alert. In some embodiments, the location data includes a location generated by a second electronic device communicatively coupled to the electronic device that generated the emergency alert. The location ingestion module 251 is integrated into an electronic device 210 through a mobile application installed on the device 210 or integrated into the firmware or operating system of the electronic device 210.

In some embodiments, the location data is generated by the electronic device 210 before the emergency and is accessible to a PSAP during an emergency. For example, a taxi company may have software that transmits the location of its cars or assets to the emergency clearinghouse 250 preemptively. Thus, when an emergency arises, the location of the affected taxi can be made accessible quicker to send help. In some embodiments, the location data is generated by the electronic device 210 after the emergency has commenced and is made accessible to a PSAP during the on-going emergency. For example, updated location data of a hijacked taxi is also periodically transmitted to the emergency clearinghouse 250 and made accessible to a PSAP.

In some embodiments, the additional data ingestion module 252 is an interface for posting or receiving static or dynamic emergency profile data (hereinafter, “additional data” or “additional information”). In some embodiments, additional data comprises medical data, personal data, demographic data, health data, or any combination thereof. Examples of medical data include information relating to a person's medical history, such as past surgeries or preexisting conditions. Examples of personal data include a person's name, date of birth, height, weight, occupation, address(es) (e.g., home address, work address, etc.), spoken languages, and other personal information. Examples of demographic data include a person's gender, ethnicity, age, etc. Examples of health data include information such as a person's blood type or heartrate. In some embodiments, additional data comprises data received from connected devices such as vehicles, IoT devices, and wearable devices. For example, some intelligent vehicle systems generate and send data regarding a crash, such as the speed at which the vehicle was moving just before the collision, where the vehicle was struck, the number of occupants, etc. In some embodiments, the additional data ingestion module 252 is a REST API (e.g., a JSON (JavaScript Object Notation) REST API). For example, in some embodiments, when an emergency call is made from a cell phone, thereby generating an emergency alert, the cell phone receives a heartrate of the person who made the emergency call from a smartwatch worn by the person and communicatively coupled to the cell phone (e.g., Wi-Fi or Bluetooth connectivity). The cell phone sends the heartrate to the additional data ingestion module 252, along with any other additional data, in an HTTP POST. In some embodiments, the additional data ingestion module 252 is integrated into an electronic device 210 through a mobile application installed on the device 210 or integrated into the firmware or operating system of the electronic device 210. In some embodiments, additional data is sent to the additional data ingestion module 252 from a network server. The additional data ingestion module 252 is accessed by any connected platform that receives data that might be relevant in an emergency. Connected platforms optionally send additional data to the additional data ingestion module 252 at any time. For example, in some embodiments, a website, web application, or mobile application integrated with the additional data ingestion module 252 that allows users to create profiles sends additional data included in the profiles to the additional data ingestion module 252 every time a profile is created or updated.

In some embodiments, the set of ingestion modules 258 includes one or more other data ingestion modules 253. Another data ingestion module 253 is optionally an interface for posting or receiving data relevant to emergencies that is not received by the location ingestion module 251 or the additional data ingestion module 252. In some embodiments, the other data ingestion module 253 receives audio or video streams during an emergency from electronic or communication devices associated with the emergency or proximal to the emergency. For example, an emergency alert is generated by an intelligent vehicle system installed in a vehicle in response to the vehicle experiencing a collision. In this example, the emergency alert is sent to the EMS 120 by the intelligent vehicle system or by an electronic device communicatively coupled to the intelligent vehicle system, such as a cell phone coupled to the intelligent vehicle system via Bluetooth. In response to generating the emergency alert, the intelligent vehicle system additionally begins streaming audio and video from microphones and cameras installed inside or outside of the vehicle to the clearinghouse 250 through the other data ingestion module 253. A cell phone communicatively coupled to the intelligent vehicle system additionally or alternatively streams audio or video from microphones and cameras integrated into the cell phone to the clearinghouse 250 through the other data ingestion module 253. In some embodiments, the one or more other data ingestion modules 253 are REST APIs that are accessed with an HTTP POST.

After receiving the relevant data, the set of ingestion modules 258 can store the data in one or more clearinghouse databases 257. For example, in some embodiments, the clearinghouse databases 257 includes a location database and an additional data database. In some embodiments, as described above, the one or more clearinghouse databases 257 are stored on a third-party server communicatively coupled to or otherwise accessible by the EMS 120. In some embodiments, the set of ingestion modules 258 tags or otherwise associates the data received by the modules with an identifier of a user or device associated with the data. For example, the set of ingestions modules 258 tag the data the received by the modules with a user ID number, an email address, or a phone number (e.g., caller ID). In some embodiments, the ingestion modules 258 tag the data received by the clearinghouse 250 based on the data source (e.g., device name or type, application name, username, phone number, corporate account, etc.).

In some embodiments, the emergency data maintained by the clearinghouse is purged. In some embodiments, the data is purged on a regular or periodic basis. In some embodiments, data that is older than a defined threshold is purged. In some embodiments, different data types are purged according to different schedules and/or thresholds. For example, dynamic data (e.g., data that is subject to constant or regular change) such as location data may be more likely to become out-of-date over time and so may be purged more frequently than static data such as a permanent home address, which may remain permanently in the database until it is replaced with an updated address.

In some embodiments, an individual or group of individuals are associated with multiple identifiers. For example, the location ingestion module 251 receives a location generated by a phone associated with the phone number +1-555-555-5555, associated with John Doe. The additional data ingestion module 252 also receives a heartrate from a smartwatch associated with the email address johndoe@email.com, also associated with John Doe. In this example, the set of ingestion modules 258 tag the location with the phone number “+1-555-555-5555,” tag the heartrate with the email address “johndoe@email.com,” and associate both the location and the heartrate with John Doe in the clearinghouse databases 257.

In some embodiments, as depicted in FIG. 2, the clearinghouse 250 includes a set of retrieval modules 259. The set of retrieval modules 259 optionally include a location retrieval module 254, an additional data retrieval module 255, and one or more other data retrieval modules 256. In some embodiments, the location retrieval module 254 is an interface for retrieving location data from the clearinghouse databases 257. In some embodiments, the location retrieval module 254 is a JSON REST API that receives a query or request (e.g., in the form of an HTTP GET request) from a requesting party, such as an ESP. In some embodiments, the request is sent from a call-taking application (e.g., call taking module 145) integrated into the ESP system 130. In some embodiments, the request (also referred to as an “emergency data request”) is sent from an emergency response application 260. In some embodiments, the location retrieval module 254 provides a single GET endpoint for retrieving either the latest or paginated list of locations for a specific caller ID (e.g., an identifier of a user or an electronic device associated with a user, such as a phone number). For example, as described above, a phone number associated with a device 210 from which a location was received is included in the header, body, or metadata of the request sent to the location retrieval module 254. The clearinghouse 250 then retrieves a location or set of locations from the clearinghouse databases 257 and deliver the location or set of locations to the requesting party. In some embodiments, the location retrieval module 254 is a location information server (LIS). In some embodiments, the LIS is a NG911 standards-based XML API for the retrieval of location data from the clearinghouse databases 257. In some embodiments, as described above, the location retrieval module 254 accepts HELD requests from requesting parties and returns location data for a specific caller ID or anonymous reference. However, in some embodiments, the location retrieval module 254 automatically retrieves and transmits location data using a subscription system, as described below.

As depicted in FIG. 2, the set of retrieval modules 259 optionally include an additional data retrieval module 255. In some embodiments, the additional data retrieval module 255 is a JSON REST API for the retrieval of emergency or additional data. As described above, additional data optionally includes medical data, personal data, demographic data, and health data. Additional data also optionally includes data received from connected devices such as vehicles, IoT devices, and wearable devices. In some embodiments, the additional data retrieval module 255 receives a query or request (e.g., in the form of an HTTP GET request) from a requesting party, such as an ESP. In some embodiments, the request (also referred to as an “emergency data request”) is sent from an emergency response application 260. The additional data then retrieves additional data associated with a specific or particular identifier of a user or an electronic device associated with the user, such as a phone number, and returns the data to the requesting party. In some embodiments, the set of retrieval modules 259 further includes one or more other data retrieval modules 256, which function similarly to the location retrieval module 254 and additional data retrieval module 255, for the retrieval of data stored in the clearinghouse databases 257 not retrieved by the location retrieval module 254 or additional data retrieval module 255. However, in some embodiments, the additional data retrieval module 255 automatically retrieves and transmits additional data using a subscription system, as described below.

In some embodiments, a retrieval module within the set of retrieval modules 259 and a corresponding ingestion module within the set of ingestion modules 258 form a sub-clearinghouse. For example, in some embodiments, location ingestion module 251 and location retrieval module 254 combine to form location clearinghouse 150A (as shown in FIG. 1B). Likewise, in some embodiments, additional data ingestion module 252 and additional data retrieval module 255 combine to form additional data clearinghouse 150B. In some embodiments, a requesting party is only given access to a particular sub-clearinghouse. For example, a police officer is only given access to the location clearinghouse 150A, while an EMT (emergency medical technician) is only given access to the additional data clearinghouse 150B. However, a requesting party is given differential access to the clearinghouse 150, sub-clearinghouses, or particular emergency data categories within the clearinghouse 150 based on any factor or set of factors. In some embodiments, a requesting party initiates a query or request (e.g., an emergency data request) using an emergency response application 260 (as described below), which in turn generates the query and transmits the query to the clearinghouse 250.

In some embodiments, the clearinghouse 250 includes an emergency data streaming module or streaming module (not shown). In some embodiments, a streaming module is capable of both receiving and transmitting emergency data, but emergency data received by the streaming module is not stored within a database. Instead, emergency data is streamed through the streaming module without being committed to memory within the clearinghouse 250. In some embodiments, the streaming module establishes an active or persistent communication link (e.g., a websocket connection, as described below) between the EMS or clearinghouse 250 and an emergency data recipient. For example, in some embodiments in which emergency data is pushed from the EMS or clearinghouse 250 to an emergency data recipient, the streaming module can establish a persistent communication link between the EMS or clearinghouse 250 and the emergency data recipient, and any emergency data that is received by the EMS or clearinghouse 250 to which the emergency data recipient is subscribed (as described below) is pushed to the emergency data recipient through the persistent communication link without being committed to memory within the EMS or clearinghouse 250.

As described above, in some embodiments, an emergency management system (EMS) maintains a clearinghouse 250 that obtains and shares emergency data to aid emergency service providers (ESPs) in responding to emergencies. During an emergency, in some embodiments, an ESP can send an emergency data request to the EMS through the emergency response application 260, and, in response, the EMS can send any available emergency data associated with the emergency back to the emergency response application 260. In some embodiments, as described above, the emergency response application 260 includes an identifier associated with an emergency alert in the emergency data request. The EMS can then use the identifier associated with the emergency alert to retrieve emergency data associated with the emergency alert from the clearinghouse. For example, as described above, an ESP 230 (e.g., a public safety answering point (PSAP)) can receive an emergency alert in the form of a 9-1-1 phone call (representative of an emergency or potential emergency) from a mobile phone associated with a phone number (e.g., (555) 555-5555). The ESP 230 can then send an emergency data request including the phone number (e.g., the identifier of the emergency alert) to the EMS, which can then retrieve any emergency data within or otherwise accessible by the clearinghouse 250 associated with the phone number and return the available emergency data to the requesting ESP 230. In this way, the requesting ESP 230 is determined to have authority to access the emergency data when the emergency location falls within the authoritative geofence of the requesting ESP 230. This maintains the integrity of the clearinghouse data such that the emergency data is released to the authorized party and a PSAP in California cannot access emergency data from New York. This process of returning emergency data to the emergency response application 260 in response to an emergency data request is referred to as “pulling” emergency data from the clearinghouse

### Emergency Data Geofencing

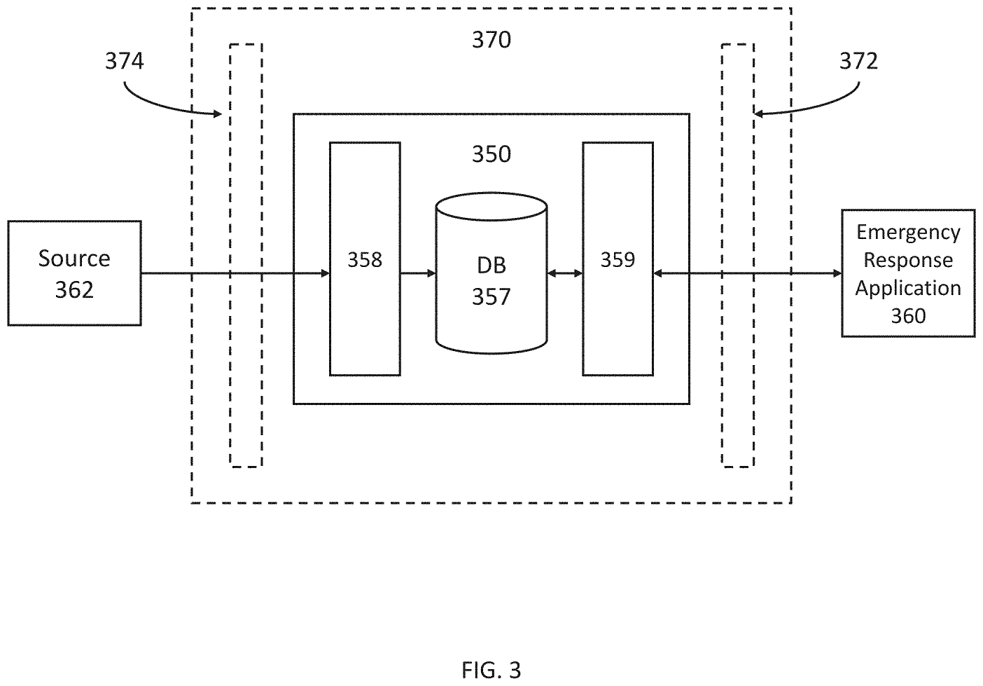

FIG. 3 depicts a diagram of a geofence applied to a clearinghouse for emergency data. In some embodiments, a geofence module 370 is applied to the clearinghouse 350 to protect potentially sensitive emergency data using geospatial analysis. In some embodiments, as described above with respect to FIG. 2, the clearinghouse 350 includes a set of ingestion modules 358 and a set of retrieval modules 359. The set of ingestion modules can receive emergency data, or other information that can be useful in responding to an emergency, from a variety of sources. For example, in some embodiments, a smartphone sends emergency data to the clearinghouse 350 in the form of an HTTP POST API call in response to a user of the smartphone initiating a 911 emergency call. As depicted in FIG. 3, in some embodiments, when emergency data (e.g., an emergency location or additional emergency data) is sent (directly or indirectly, such as through a third-party server) from an electronic device 310 to the clearinghouse 350, the emergency data is first processed by a geofence module 370 before being received by the set of ingestion modules 358 within the clearinghouse 350. Similarly, in some embodiments, when an emergency data request is sent from a requesting party (e.g., through an emergency response application 360, as described below), the emergency data request is processed by the geofence module 370 before being received by the set of retrieval modules 359.

In some embodiments, as mentioned above, a geofence module 370 is applied to the clearinghouse 350 to protect potentially sensitive emergency data using geofences. Generally, a geofence is a virtual perimeter for a real-world geographic area. A geofence can be dynamically generated—as in a radius around a point location—or a geofence can be a predefined set of boundaries (such as school zones or neighborhood boundaries). The use of a geofence is called geofencing, and one example of usage involves a location-aware device of a location-based service (LBS) user entering or exiting a geofence. Entry or exit from a geofence could trigger an alert to the device's user as well as messaging to the geofence operator. The geofence information, which could contain the location of the device, could be sent to a mobile telephone or an email account.

For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. In some embodiments, geofences only represent authoritative regions if the geofence has been assigned or verified by a local, state, or federal government. In some embodiments, geofences represent assigned jurisdictions that are not necessarily authoritative regions. For example, in some embodiments, a geofence is unilaterally created by its associated ESP without verification or assignment by a local, state, or federal government.

Geofences can be defined in various ways. For example, in some embodiments, a geofence comprises one or more of the following: a county boundary, a state boundary, a collection of postal/zip codes, a collection of cell sectors, simple shapes, complex polygons, or other shapes or areas. In some embodiments, geofences comprise approximations where the “approximated” geofence encloses an approximation of the authoritative region.

Updates to geofences may be required over time because the authoritative regions may change over time. Geofences may change over time (e.g., a new sub-division has cropped up) and require updates. In some embodiments, the systems and methods described herein allow geofences to be updated (e.g., a PSAP administrator can upload updated geofence GIS shapefiles).

For maintaining the privacy, security and integrity of the data, geofencing may be applied to emergency data. For example, applying geofence filters to the emergency data allows additional avenues for monitoring, both visibility and control, over the clearinghouse to detect anomalies/spikes and reduce the risk of security breaches.

In some embodiments, the emergency data is obtained or received from an emergency data source 362 (such as an electronic device or third-party server, as described above) by the clearinghouse 350. Then, geofencing can be applied to the emergency data in various ways. In some embodiments, an ingestion geofence 374 (also referred to as “upstream filtering”) is applied to restrict sending of data from emergency data sources 362 to the clearinghouse 350 from geographical areas that are not covered by the “combined authoritative jurisdiction” (e.g., covered one or more provisioned geofences in the geofence database 376). In such an embodiment, the geofence module 370 identifies a location associated with the emergency data (e.g., a device-based hybrid location received from a mobile phone as part of an emergency alert) and determines if the location falls within any of the geofences stored within the geofence database 376. In some embodiments, the ingestion geofence (also referred to as an “ingress filter”) is applied to the ingestion module 358 to protect against accidental breaches of privacy. In some embodiments, the ingestion module 358 of the clearinghouse 350 drops location payloads that do fall within the geographical region covered by the “combined authoritative region.” In some embodiments, geofencing is applied to determine if a location associated with emergency data received by the clearinghouse 350 falls within any of the geofences stored within the geofence database 376, and, if so, which entity is associated with the geofence that the location falls within, as described below.

In some embodiments, the clearinghouse 350 comprises one or more databases 357 (e.g., a database storing emergency data). For example, in some embodiments, the retrieval module 359 obtains emergency data from a clearinghouse database 357 to send to an emergency data recipient (e.g., an ESP) in response to an emergency data request, as described above. In some embodiments, the retrieval geofence 372 (also referred to as an “egress filter”) is applied at the retrieval module 359 of the clearinghouse 350. Applying geofencing to retrieved emergency data will protect against abuse and limit the scope of security breaches in cases where credentials have been compromised. In some embodiments, one or more geofences are associated with one or more credentials associated with an ESP agency or organization. In some embodiments, the credentials associated with an ESP agency or organization confers authorization to access data such as emergency data from the clearinghouse. In some embodiments, specific authorization to access data is granted individually to members of a PSAP through tokens derived from the credentials for that PSAP.

In some embodiments, when the retrieval module 359 checks the coordinates of current location data (within retrieved emergency data) associated with a device identifier with the geofence(s) associated with the credentials in an emergency data request. If the current location is within the geofence region (enclosed by the geofence(s)), the current location is returned to the ESP and displayed within the ESP console. If not, the module 359 will return a “not found” message (as opposed to the retrieved location is outside the geofence) to protect privacy.

In some embodiments, geofences can be used for reporting results for internal metrics and monitoring the system. For example, the number of emergency data requests, locations provided, “no location found” etc., can be obtained for a geofence(s) associated with a PSAP. Using single or combined geofences, the emergency data can be obtained on county-wide, city-wide, postal code, course grid (rectangle overlay), state-wide, or country-wide basis. In some embodiments, ingress and egress counters (e.g., percent of emergency sessions where the location data was received, but not queried) and other similar metrics can be calculated and analyzed to identify problems and spikes. In some embodiments, different geofences are used for retrieval and for reporting.

In some embodiments, a location associated with a given emergency can be determined to fall within a plurality of geofences, as described below. In some embodiments, emergency data for the emergency is pushed to each PSAP having a geofence that the emergency (e.g., the location associated with the emergency) falls within. In some embodiments, emergency data for the emergency is transmitted to a subset of PSAPs having a geofence that encloses or encompasses the location associated with the emergency. In some embodiments, the location data of an individual device identifier is not transmitted to more than one PSAP at one time. Thus, the emergency data is only transmitted to one PSAP (e.g., a primary agency), but may be transmitted to multiple secondary agencies (e.g., police departments) and regional agencies. In some embodiments, the emergency data is transmitted to one or more emergency responders who may be associated with an ESP (e.g., police officers working for a police department). In some embodiments, wherein a device identifier egresses a geofence in which communication began and ingresses into a neighboring geofence, the location data is automatically transmitted to the neighboring PSAP with jurisdiction over the ingress geofence.

In some embodiments, to determine the appropriate ESP(s) for sharing emergency data, the authoritative jurisdiction (defined by one or more geofences) of an ESP (e.g., primary agency) must be evaluated before it is used by the geofence module 370. In case of irregularities (e.g., overlaps, islands, or other irregular features), steps may be taken to check with respective agency, geographical boundaries (national and international borders, county lines, rivers, hills, etc.), or other authority. In some embodiments, call routing data may be analyzed to see which ESP is answering the emergency call.

Raw geofences may be pre-processed to generate processed geofences using a variety of techniques. For removing irregularities, a geofence may be processed to resolve overlaps, remove islands and projections, smooth boundaries, modifying the file format or size, etc.

In some cases, there may be overlap between geofences of two or more ESPs. In some embodiments, the emergency data may be shared with the two or more ESPs to err on the side of making mission critical information to all entities that may be involved in the emergency response. In some embodiments, the two or more ESPs are primary agencies (e.g., PSAPs) and the emergency data has to be shared with one appropriate ESP. To determine the appropriate ESP(s) for sharing emergency data, the authoritative jurisdiction (defined by one or more geofences) of the overlapping ESPs by checking with respective agency, geographical boundaries (national and international borders, county lines, rivers, hills, etc.), sample routing data, etc. In contrast, if the overlapping ESPs include one or more secondary ESPs, the overlap may be retained and emergency data may be shared with one or more ESPs (e.g., one primary agency and two secondary agencies).

In some embodiments, a buffer (e.g., +10 km) is added to the geofence(s) so that results within the buffer zone are also returned. In many cases, PSAPs have discretion and incentive to respond to emergencies that are beyond their authoritative jurisdiction. As an example, a geofence that is a circular area with a radius of 10 km would have an area of 100 π or ˜314 km2, whereas the same area with a 10 km buffer around its circumference would have yield a combined radius of 20 km and a combined area of 400 π or 1256 km2. In some embodiments, the buffer is from 0.5 km to 5 km, from 0.5 km to 10 km, from 0.5 km to 15 km, from 0.5 km to 20 km, from 0.5 km to 25 km, or from 0.5 km to 30 km. In some embodiments, the buffer is from 1 km to 5 km, from 1 km to 10 km, from 1 km to 15 km, from 1 km to 20 km, or from 1 km to 30 km. In some embodiments, the buffer is at least 0.1 km, at least 0.2 km, at least 0.3 km, at least 0.4 km, at least 0.5 km, at least 0.6 km, at least 0.7 km, at least 0.8 km, at least 0.9 km, at least 1 km, at least 2 km, at least 3 km, at least 4 km, at least 5 km, at least 6 km, at least 7 km, at least 8 km, at least 9 km, at least 10 km, at least 11 km, at least 12 km, at least 9 km, at least 14 km, at least 15 km, at least 16 km, at least 17 km, at least 18 km, at least 19 km, at least 20 km, at least 25 km, or at least 30 km. In some embodiments, the buffer is no more than 0.1 km, no more than 0.2 km, no more than 0.3 km, no more than 0.4 km, no more than 0.5 km, no more than 0.6 km, no more than 0.7 km, no more than 0.8 km, no more than 0.9 km, no more than 1 km, no more than 2 km, no more than 3 km, no more than 4 km, no more than 5 km, no more than 6 km, no more than 7 km, no more than 8 km, no more than 9 km, no more than 10 km, no more than 11 km, no more than 12 km, no more than 9 km, no more than 14 km, no more than 15 km, no more than 16 km, no more than 17 km, no more than 18 km, no more than 19 km, no more than 20 km, no more than 25 km, or no more than 30 km.

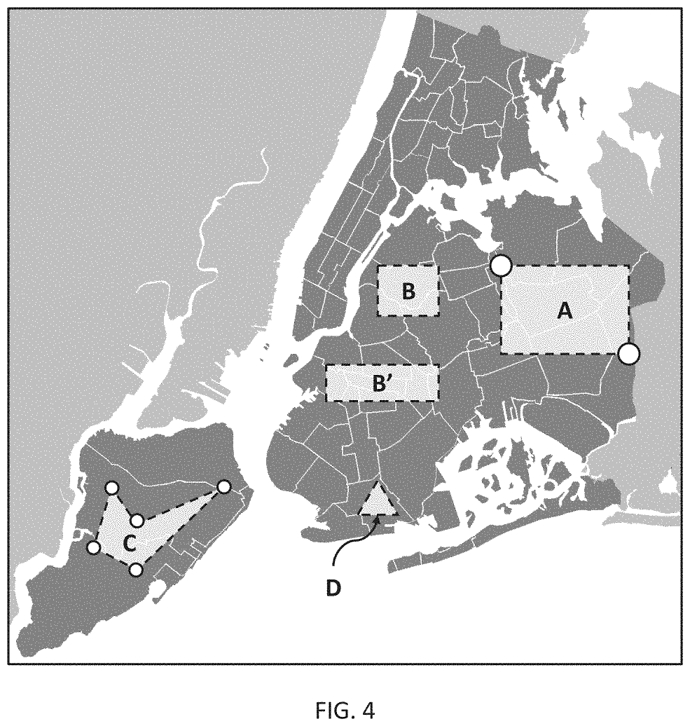

FIG. 4 illustrates non-limiting examples of geofence approximations that may be submitted as an “authoritative jurisdiction” for an ESP. One or more geofences enclose the geofenced region which is under the authoritative jurisdiction of an ESP. In some cases, the geofenced region may be a complex polygon, but it may be approximated using an appropriate shape. For example, a rectangle (A), two disjointed rectangles (B, B′), a polygon with several sides (C) and a triangle (D), may represent different geofenced regions (defined by one or more geofences).

In some embodiments, an administrator of a PSAP submits the complex authoritative jurisdiction as one or more approximate geofence(s) by specifying points. For example, the PSAP administrator can submit geofenced region A by specifying two points—the north-west corner and the south-east corner using a drawing tool provided by the GUI of an emergency response application. In this example, the two points of the geofenced region are set using two latitude-longitude coordinates. In another example, the multiple-sided polygon C is submitted by specifying the five corners. In some embodiments, a PSAP administrator approximates a geofence for a PSAP by drawing one or more polygons using a drawing tool provided by the GUI of the emergency response application. In some embodiments, a geofence is generated using a series of points that are connected (e.g., entering three longitude-latitude points on a map to form a triangular geofence).

Approximating a complex geofenced region has several advantages. The geofence(s) are simple and the calculations can be quicker and less cumbersome for applications where exact calculations are not needed.

In some embodiments, a PSAP administrator can submit a GIS file (e.g., a shapefile) that represents the actual authoritative jurisdiction of the PSAP, which may then be provisioned in a geofence database. It is appreciated that a GIS file defining the authoritative jurisdiction may be saved in one or more industry-acceptable formats such as a shapefile, a GeoJSON file, KML file, etc. In some embodiments, the GIS file includes one or more features such as points, lines, polygons, density, and other shapes. A GeoJSON is open standard GIS file representing geographical features and non-spatial attributes based on JavaScript Object Notation. Some non-limiting examples of features include points (such as addresses and locations), line strings (streets, highways and boundaries), polygons (countries, provinces, tracts of land), and multi-part collections of these types. A Keyhole Markup Language (KML) file includes geographic annotations and visualization on internet-based maps on Earth browsers. A shapefile is a vector data format for storing the location, shape, and attributes of geographic features. A shapefile is stored in a set of related files, each of which may contain one feature class (e.g., lines, points, polygons, etc.). In some embodiments, the shapefile is a file with extension .SHP in ESRI file format where SHP is the feature geometry, SHX is the shape index position and DBF is the attribute data.

Various embodiments of the geofence database are contemplated. In some embodiments, one or more databases are searchable using a PSAP identifier, credentials, or other information. In some embodiments, an emergency location is searched through several geofences in the geofence database. In some cases, the geofenced region is shrunk for ease of storage and to simplify calculations.

### Emergency Response Application

As mentioned above, in some embodiments, data and information is shared between the emergency management system (EMS) and an emergency service provider (ESP) through an emergency response application. In some embodiments, the emergency response application is a software application either installed on a computing device at the ESP or accessed via the internet through a web browser on the computing device (e.g., the emergency response application is hosted on a cloud computing system by the EMS). Generally, the emergency response application functions to both facilitate a two-way communication link between the EMS and the ESP and visualize data (e.g., emergency data) received by the ESP from the EMS. The emergency response application 560 optionally includes various components, such as a frontend application (hereinafter “graphical user interface” or “GUI”), a backend application, an authorization module, and a user database. In some embodiments, the emergency response application 560 additionally or alternatively includes a credential management system or a geofence module. In some embodiments, the credential management system and the geofence module are external to the emergency response application 560 and communicatively coupled to the emergency response application 560 (e.g., the credential management system or geofence module can be housed or hosted on a cloud computing system by the EMS). Any or all of the components of the emergency response application may be hosted on a cloud computing system by the EMS, a computing device at an ESP, or some combination thereof

In some embodiments, the emergency response application 560 is a webpage or web application that can be accessed through an interne or web browser. In such embodiments, the emergency response application 560 can be quickly and easily integrated into the systems used by emergency service providers (ESPs), such as public safety answering points (PSAPs), because accessing and using emergency response application 560 requires no additional software or hardware outside of standard computing devices and networks. As previously discussed, one of the greatest hinderances that PSAPs face in providing emergency assistance to people experiencing emergency situations is in acquiring accurate locations of the emergencies and the people involved, because PSAPs are currently typically limited to verbally asking for and verbally receiving locations from callers. In some embodiments, the clearinghouse is capable of receiving accurate locations (as well as additional emergency data, as described above) from electronic devices such as smartphones and delivering the accurate locations to the appropriate PSAPs during emergency situations. Therefore, it is advantageous to provide the emergency response application 560 to PSAPs in the form of a webpage accessible through a standard web browser, in order to provide the potentially life-saving information stored within the clearinghouse to those capable of providing emergency assistance as quickly and easily as possible. However, in some embodiments, the emergency response application is a software application installed on a computing device at an ESP. The emergency response application may be provided by the EMS or by a third-party.

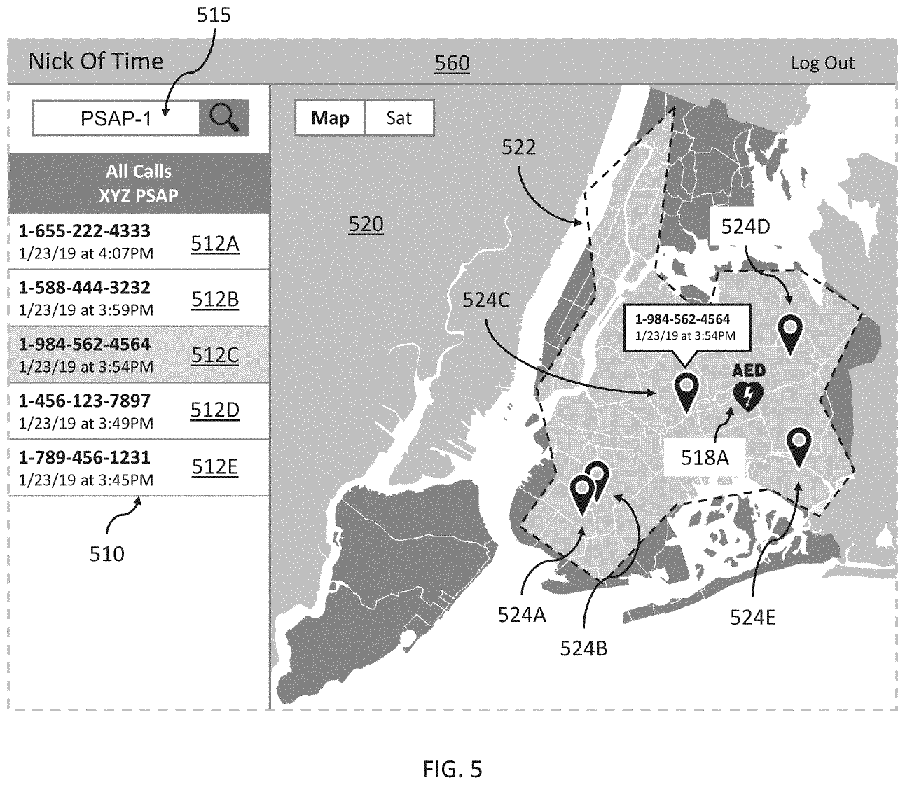

FIG. 5 illustrates an embodiment of a graphical user interface (GUI) provided by an emergency response application 560. The dashboard is a page within the GUI that provides interactive elements that allow a user at an ESP to receive data from the EMS, visualize data received from the EMS, and transmit data to the EMS. For example, in some embodiments, the dashboard includes an entry field 530 through which a user can submit a device identifier, such as by typing or pasting the device identifier into the entry field 530.

Previously, a device identifier (e.g., a phone number) could be entered query through the entry field 515, the user can prompt the emergency response application to generate and send an emergency data request by selecting a search button (referred to as “Device-based query”). The emergency response application 560 then generates an emergency data request including the device identifier and any other necessary information (e.g., a temporary access token) and transmits the emergency data request to the EMS. The EMS can then return any available emergency data associated with the device identifier to the emergency response application 560, as described above and below. Herein, the retrieved result would retrieve results for one device identifier (e.g. a phone number), typically, corresponding to one emergency alert.

### Emergency Spatiotemporal Query

In the present invention, spatiotemporal queries for emergency data are contemplated, which is a shift from device-based queries. For spatiotemporal queries, the retrieved results may be zero to multiple emergency alerts, which may be depicted on a map.

For example, in some embodiments, the emergency response application 560 includes a list of incidents (or verified emergency alerts) 510 and an interactive map 520, as illustrated by FIG. 5. As shown, the spatiotemporal query is “PSAP-1”, which is the identifier of a specific emergency service provider. Assuming the requesting party has authorization (e.g., PSAP-1 is within the regional jurisdiction of the state agency), the emergency response application 560 will first retrieve the geofences associated with PSAP-1 as described in relation to FIGS. 3 & 4. Second, the geofences associated with PSAP-1 will be queried to return all verified emergency alerts within the jurisdiction of PSAP-1. Herein, the geofence(s) for PSAP-1 will be the spatiotemporal query. In some embodiments, the retrieved results show emergencies occurring within the jurisdiction 522 of the receiving ESP. In some embodiments the emergency response application 560 displays the location associated with the emergency within the interactive map 520 as a location marker 524 and displays the device identifier associated with the emergency within the list of incidents 510 as an incident 512.

In some embodiments the spatiotemporal query are geofences associated with a requesting ESP, which may be a GIS file defining the authoritative jurisdiction may be saved in one or more industry-acceptable formats such as a shapefile, a GeoJSON file, KML file, etc. In some embodiments, the GIS file includes one or more features such as points, lines, polygons, density, and other shapes. In some embodiments, the spatiotemporal query is a shapefile is a file with extension .SHP in ESRI file format where SHP is the feature geometry, SHX is the shape index position and DBF is the attribute data.

In addition to emergency locations, the emergency response application 560 can receive and visualize numerous types of emergency data from the EMS. For example, the emergency response application 560 can receive additional data regarding an emergency, such as demographic or medical data associated with a person involved in the emergency (e.g., an emergency caller). In another example, the emergency response application 560 can receive data from sensors associated with the emergency, such as heartrate data collected by a sensor on an emergency caller's smartwatch. Or, for example, the emergency response application 560 can receive data regarding emergency response assets available for an emergency, as described below. The emergency response application 560 can visualize any emergency data received from the EMS within the GUI of the emergency response application.

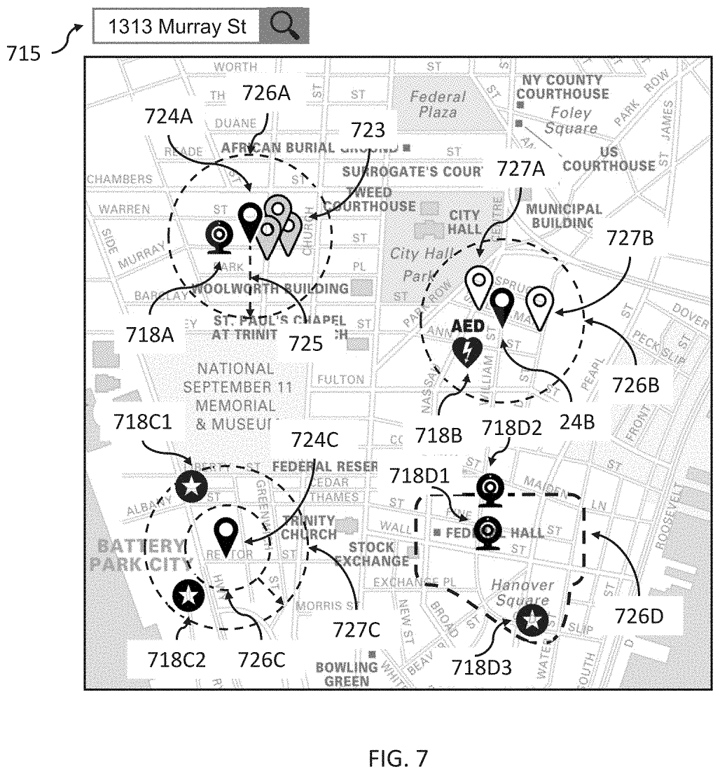

As depicted, the emergency response application displays five different incidents 512 (e.g., incidents 512A-512E) within the list of incidents 510 and five corresponding incident locations 524 (e.g., incident locations 524A-524E) within the interactive map 520. As illustrated by FIG. 5, in some embodiments, incidents 512 and incident locations 524 may be selected or hovered over to highlight a particular incident 512. In this example, incident 512C and its corresponding incident location 524C have been selected and highlighted. In some embodiments, selecting a particular incident 512 or corresponding incident location 524 prompts the emergency response application 560 to display additional information associated with the particular incident 512 (e.g., additional emergency data or information associated with the emergency alert for which the particular incident 512 was created). Because the jurisdiction view can show an ESP numerous incidents 512 occurring within the jurisdiction 522 of the ESP simultaneously, the spatiotemporal query for its jurisdiction can provide the ESP with situational awareness that the ESP otherwise would not have. For example, with the knowledge that incidents 512A and 512B originated in close proximity and at approximately the same time, an ESP personnel (e.g., a call taker at a public safety answering point) can determine that the two incidents may be related. In addition to emergency alerts, spatiotemporal queries may be used to retrieve emergency response resources around an emergency location as shown in FIG. 7. Emergency response resources may include responders, safety assets, etc. For example, AED 518A may be shown in the display at the ESP, which may be relevant if the emergencies 524A-E is a medical emergency involving a cardiac patient.

### Emergency Data Queries

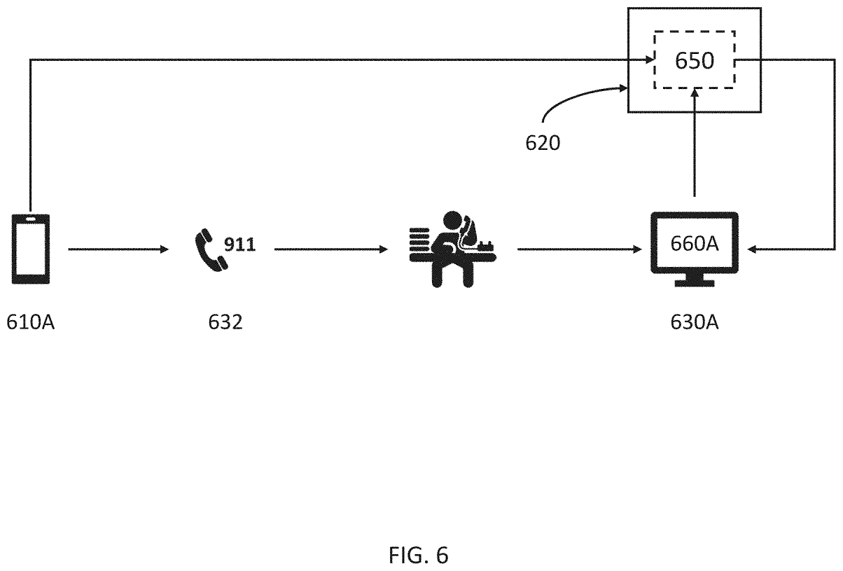

FIG. 6 depict systems and processes for receiving and transmitting emergency data by an emergency management system in accordance with some embodiments of the present disclosure. As described above, in some embodiments, an emergency management system (EMS) maintains a clearinghouse that obtains and shares emergency data to aid emergency service providers (ESPs) in responding to emergencies. For example, as depicted in FIG. 6A, during an emergency, an ESP 630A can send an emergency data request to the EMS 620 (e.g., through an emergency response application 660A), and, in response, the EMS 620 can send any available emergency data associated with the emergency back to the emergency response application 660A. In some embodiments, as described above, the emergency response application 660A includes an identifier associated with an emergency alert in the emergency data request. The EMS 620 can then use the identifier associated with the emergency alert to retrieve emergency data associated with the emergency alert from the clearinghouse 650. For example, as described above, an ESP 630A (e.g., a public safety answering point (PSAP)) can receive an emergency alert in the form of a 9-1-1 phone call 632 (representative of an emergency or potential emergency) from a mobile phone 610A associated with a phone number (e.g., (555) 555-5555). The ESP 630A can then send an emergency data request including the phone number (e.g., the identifier associated with the emergency alert) to the EMS 620, which can then retrieve any emergency data within the clearinghouse 650 associated with the phone number and return the available emergency data to the requesting ESP 630A. This process of returning emergency data to an ESP in response to an emergency data request is referred to as “pulling” emergency data from the clearinghouse.

In some embodiments, a member of an ESP (e.g., a PSAP staff member) logs into the emergency response application 660A at an ESP console 630A (e.g., a computing device associated with the ESP) by accessing the emergency response application 660A (e.g., by navigating to the emergency response application 660A through a web browser) and submitting their login information through the GUI of the emergency response application 660A. In some embodiments, when the ESP member logs into the emergency response application 660BAby submitting their login information, the emergency response application 660A or EMS 620 then determines an ESP account ID associated with the ESP member's account and establishes a persistent or active communication link (e.g., a websocket connection) with the ESP console 630A.

### Emergency Spatiotemporal Analysis

As described above, in some embodiments, an emergency clearinghouse functions to receive, store, or otherwise access emergency data from any number of a variety of different sources, such as mobile phones, IoT devices (e.g., CCTV cameras), safety assets (e.g., AEDs) In some embodiments, emergency data about emergency responders (location of responders, facilities and vehicles) are critical information that can be retrieved using spatiotemporal queries.

In many instances, individual units of emergency data (hereinafter, “emergency response resources”) have either or both of a spatial attribute (e.g., a location or a geofence) and a temporal attribute (e.g., a time or a timestamp). For example, information regarding an emergency alert may include both a time and a location, indicating where and when the emergency alert was generated or transmitted; information regarding a first responder (e.g., a policeman) may include both a time and a location, indicating when the first responder was where; information regarding an emergency service provider (ESP) may include a geofence associated with the ESP, indicating the authoritative region of the ESP; information regarding an emergency response asset may include a location, geofence, or asset range to indicate where the emergency response asset is available (information regarding an emergency response asset may also include a time, although time may be a moot attribute for a stationary emergency response asset, such as a smart building system, as described below).

Thus, in some embodiments, as described herein, a spatiotemporal analysis of emergency data received, stored, or otherwise accessed by the emergency clearinghouse may be performed to determine, at a given point or period of time, what emergency response resources (e.g., emergency alerts or emergency response resources, such as first responders, emergency response assets, etc.) exist within a given space. Such information may be helpful to emergency service providers in providing emergency response. In some embodiments, a spatiotemporal analysis of emergency data (hereinafter, an “emergency spatiotemporal analysis”) may additionally or alternatively include determining one or more relational attributes of an emergency response element, such as a landmark location for an emergency alert, as described below. In some embodiments, an emergency spatiotemporal analysis may additionally or alternatively include determining if an emergency alert is representative of an auto emergency.

A method for providing emergency data through spatiotemporal analysis is contemplated. A representative area for the emergency spatiotemporal analysis is defined in various ways. For example, an ESP personnel may enter an emergency location (e.g., a street address) as shown in FIG. 7 and a proximate area is defined around the vicinity of the emergency location. In another example, an ESP identifier (e.g., a PSAP identifier) may be entered as a spatiotemporal query as shown in FIG. 5, which may be entered by the ESP personnel or automatically generated based on the log-in credentials. The representative area may be the area defined by the jurisdictional boundaries associated with the ESP.

The spatiotemporal analysis may identify one or more emergency response resources located within the representative area within an appropriate timeframe. In some embodiments, the appropriate timeframe could be entered by a user, such as an ESP personnel (referred to as “user-defined timeframe). This user input can specify the parameters of the timeframe based on information about the emergency response resource. For example, the user may set a timeframe requiring data from a sensor (e.g., video feed from a door camera) to have a timestamp of within the last 24h. In some embodiments, the appropriate timeframe is defined based on the type of resource as described below.

In some embodiments, the length of the timeframe is based at least partly on information about the one or more emergency response resources or user input. For example, the appropriate timeframe is based on the type of resource. For example, the appropriate timeframe is set to a default based on whether the resource is static or mobile, expiration date, maintenance schedule, etc.

Thus, a static resource such as building camera may be returned even if the entry is older, e.g., a default timeframe for a CCTV camera may be set to within 1 year. In contrast, a mobile resource such as a drone will be returned in a shorter timeframe, e.g., default timeframe may be set to 1-30 minutes. In addition, time attributes regarding an emergency resource such as expiration date, maintenance schedule can also be entered and provided to the ESP personnel.

It is understood that using an appropriate timeframe for the spatiotemporal analysis is an important factor in presenting meaningful and actionable information for ESP personnel. Using the same timeframe for different types of resources may not lead to meaningful results. If only recent entries are analyzed, long-standing static resources may not returned even if they could be utilized. If a larger timeframe is analyzed, a large number of resources may be returned with many mobile resources no longer in the area. During an emergency response, the ability to return actionable results to ESP personnel can save precious time and lives.

In some embodiments, it is contemplated that the ESP personnel can check on the status of a resource, particularly if it is an older resource. For example, an ESP personnel may be prompted to check the status of a building camera to see if it is currently online. The status of a resource may be online, offline, non-responsive, low power/battery, expired, maintenance check, etc. An ESP personnel can press a button to request a responder to check in by sending a message or calling a number. In this way, a message can be sent to responders located in the area and the responder who is able to respond is contacted and dispatched.

It is contemplated that a database (e.g., emergency resources database 137) can be structured so that spatial and temporal attributes of the emergency resources can be stored and retrieved. In some embodiments, the database 137 comprise one or more database systems including, by way of non-limiting examples, relational, non-relational, object oriented, associative, and XML database systems. In some embodiments, the database(s) 137 is a relational database with time-stamped columns such as timestamp, resource ID, resource type, resource status, source, location (address, lat/lon/z-direction), contact information, static/dynamic, etc.

TABLE 1
Exemplary Emergency Resources Database

| | | | | | | | Z |
|---|---|---|---|---|---|---|---|
| Reg. | | | Resource | | | | direction |
| No. | Time/Day | Resource ID | Type | Source | Location | Lat/Lon | (meters) |
| 1 | 11-30-17 | CCTV-001 | Building | Security, | 345 Green | 40.6782/73.9442 | 10 |
| | 15:06:43 | | Camera | Inc. | Ave, 1^{st} Floor, | | |
| | | | | | Brooklyn, NY | | |
| 0 | 11-30-17 | TC-001 | Traffic | Traffic, | Green & State | 40.6785/73.9447 | — |
| | 15:06:43 | | Camera | Inc. | intersection, | | |
| | | | | | Brooklyn, NY | | |
| 3 | 11-30-17 | AED-001 | Defibrillator | Health, Inc. | 122 Forest St, | 40.6789/73.9443 | 20 |
| | 15:12:23 | | | | 2^{nd} floor, | | |
| | | | | | Brooklyn, NY | | |
| 4 | 11-30-17 | FE-101 | Fire | Fire, Inc. | 389 Broad St, | 40.6709/73.9413 | — |
| | 15:16:48 | | extinguisher | | Brooklyn, NY | | |
| 5 | 11-30-17 | DR-202 | Diagnostic | Police-1001 | 122 Forest St, | 40.6789/73.9443 | 30 |
| | 15:25:18 | | Drone | | Brooklyn. NY | | |
| 6 | 11-30-17 | POL-2359 | Police | Police-1001 | 122 Forest St, | 40.6789/73.9443 | 20 |
| | 15:27:21 | (Off. Martin | Officer | | Brooklyn, NY | | |
| | | Green) | | | | | |
| 7 | 11-30-17 | POL VH- 43 | Police | Police-1001 | 122 Forest St, | 40.6789/73.9443 | 0 |
| | 15:27:21 | (Cruiser) | Vehicle | | Brooklyn, NY | | |

As shown, each emergency response resource is associated with spatial and temporal attributes, which can be utilized in the spatiotemporal analysis to return relevant results. Here, for example, the temporal attributes are the timestamp when the entry was created. The spatial data could be in various forms including as a street address, lat/long, z-direction, what3words, etc. For example, the z-direction can indicate that the police officer (#6) is located on the second floor, the police cruiser is on the parking lot on the ground floor (#7) and the diagnostic drone (#5) is located at an elevation, such as a roof-top. A 3-directional map can be used to display the resources with z-direction attributes. In some embodiments, the results of the spatiotemporal analysis can filter results based on other attributes such as resource type, location, etc.

It is contemplated that static resources can be returned over a longer timeframe as compared to dynamic resources. For example, static emergency response resources such as cameras in buildings (#1) and traffic lights (#2) can be associated with a longer timeframe as compared to dynamic resources, such as drone (#5), police officer (#6) and police vehicle (#7). Some resources such as fire extinguisher (#4) may include an expiration date, which cannot be returned after expiration date.

After the spatiotemporal analysis retrieves the results, e.g., one or more emergency response resources within the representative area within an appropriate timeframe, the results may be transmitted to the requesting ESP. Here, various mechanisms as described in FIGS. 5 & 6 may be utilized to transmit the results. Further, the emergency response resources may be displayed at the requesting ESP as shown in FIGS. 5, 7-13.

FIG. 7 illustrates processes for performing emergency spatiotemporal analyses in accordance with some embodiments of the present disclosure. FIG. 7 shows three emergency locations 724A-724C. The spatiotemporal query 715 may be a location, such as an emergency location. As depicted, the query is a street address (“1313 Murray Street”). In other embodiments, the query may be latitude-longitude (“40.7831, 73.9712”).

The emergency locations 724 shown on the map may represent respective emergency alerts. For example, in some embodiments, as described above, when an emergency alert is generated and transmitted to an emergency management system (EMS) by an electronic device, the electronic device can generate an emergency location (e.g., a hybrid device-based location) and include the emergency location in the emergency alert. For an emergency spatiotemporal analysis to be performed, a representative area 726 for the emergency spatiotemporal analysis must be determined. In some embodiments, a representative area 726 for an emergency spatiotemporal analysis is automatically or autonomously determined or predetermined by the EMS. For example, as illustrated in FIG. 7, the EMS can determine a representative area 726 by applying a geospatial boundary around an emergency location 724. A geospatial boundary is a virtual perimeter around a geographic region and may take any shape or size (see representative area 726D).

As used herein, a representative area refers to a geographical area that is defined for spatiotemporal analysis. The representative area may be a regular or irregular shape defining a geographical area. For example, the representative area may be a circle, a regular or irregular polygon, a jurisdictional boundary for a. In some embodiments, the representative area is bounded by a natural water body (e.g., a river), an administrative body (e.g., county lines), or other structure (e.g., a highway). In some embodiments, the representative area can be visualized on a map. In some embodiments, the representative area comprises a z-direction, which defines an altitude above sea level (referred to as “3-D representative area.”

A representative area may be defined around a location (“proximate area”), which may be an address, latitude-longitude, etc. In some embodiments, a proximate area is defined around an emergency, e.g., around a location of an emergency received in an emergency alert. The proximity area may be a radius around the emergency location, as depicted. In some embodiments, the proximity area is a regular or irregular polygon around the emergency location (not shown). For example, as illustrated in FIG. 7, representative area 726A is a circle defined by a radius applied to emergency location 724A. However, in some embodiments, a representative area 726 can be defined by a square or rectangle or any other shape having an emergency location as its center. Additionally, a representative area 726 need not be defined around an emergency location or an emergency alert. In some embodiments, a representative area 726 can be defined or received by an entity external to the EMS, such as by a user of an emergency response application at an emergency service provider (ESP), as described above and below.

In addition to a representative area, an emergency spatiotemporal analysis also requires a timeframe. In some embodiments, a default timeframe may be used for the analysis. For example, if no timeframe is specified, a current timeframe (e.g., only at the moment of the spatiotemporal analysis) or a short timeframe (e.g., within 1 week, 24 hours, 1 hour, 30 minutes, 10 minutes) is assumed as a default. However, any timeframe may be specified for an emergency spatiotemporal analysis, such as the past 24 hours or the past week, or even a timeframe defined by two historical times, such as the 48 hours between last Tuesday and last Thursday. For some analysis, the timeframe may be the same day last year. For example, for the month of May during the last calendar year, last year on the Fourth of July, last year on Christmas Day, etc.

Once a representative area has been determined and a timeframe has been specified for an emergency spatiotemporal analysis, the EMS can perform the emergency spatiotemporal analysis by identifying one or more emergency response resources having a location attribute that falls within the representative area and a time attribute that falls within the timeframe. FIG. 7 illustrates three such emergency spatiotemporal analyses. In a first example, a representative area 726A has been determined around a recently received emergency location 724A (e.g., included in a recently generated and received emergency alert) by applying a radius 725 around the emergency location 724A. The timeframe has been specified as the past 24 hours. As illustrated by FIG. 7, an emergency spatiotemporal analysis performed on the representative area 726A over the specified timeframe has identified a group of three historical emergency locations 723 received by the EMS within the representative area 726A and within the past 24 hours. Knowing that four emergency locations have been received from the same vicinity within the past 24 hours can provide important contextual information for an emergency service provider. The emergency spatiotemporal analysis has also identified an emergency response resource 718A, a smart camera accessible by the EMS, which may be leveraged for emergency response.

In a second example, a representative area 726B has been determined around a recently received emergency location 724B by applying a radius around the emergency location 724B. In this example, the timeframe was not specified, so a current timeframe has been chosen as a default. As illustrated by FIG. 7, an emergency spatiotemporal analysis performed on the representative area 726B over the chosen timeframe has identified two concurrent emergency locations 727A and 727B (e.g., associated with two respective concurrent emergency alerts) within the vicinity of emergency location 724B. In this example, knowing that there are two concurrent emergency locations 727 in the vicinity of emergency location 724B can inform how an emergency service provider responds to the emergency represented by emergency location 724B. In this example, the emergency spatiotemporal analysis has also identified an emergency response resource 718B, a smart AED (as described below), which may be leveraged for emergency response.

In a third example, a representative area 726C has been determined around a recently received emergency location 724C by applying a radius around emergency location 724C. In this example, a current timeframe has been specified. As illustrated by FIG. 7, an emergency spatiotemporal analysis performed on the representative area 726C has identified no concurrent emergency alerts or emergency response resources within the representative area 726C.

If no results are generated during the spatiotemporal analysis, the representative area is expanded and re-analyzed. In some embodiments, as illustrated by FIG. 7, if the EMS does not find any emergency response resources within the representative area of a particular emergency spatiotemporal analysis, the EMS can expand the representative area and reperform the emergency spatiotemporal analysis. In this third example illustrated by FIG. 7, the EMS expands the representative area of the emergency spatiotemporal analysis from representative area 726C to representative area 727C by increasing the length of the radius around emergency location 724C. After reperforming the emergency spatiotemporal analysis (referred to as “re-analysis”) on representative area 727C, the EMS identifies two emergency response resources 718C1 and 718C2, two police officers that can be alerted of the emergency represented by emergency location 724C.

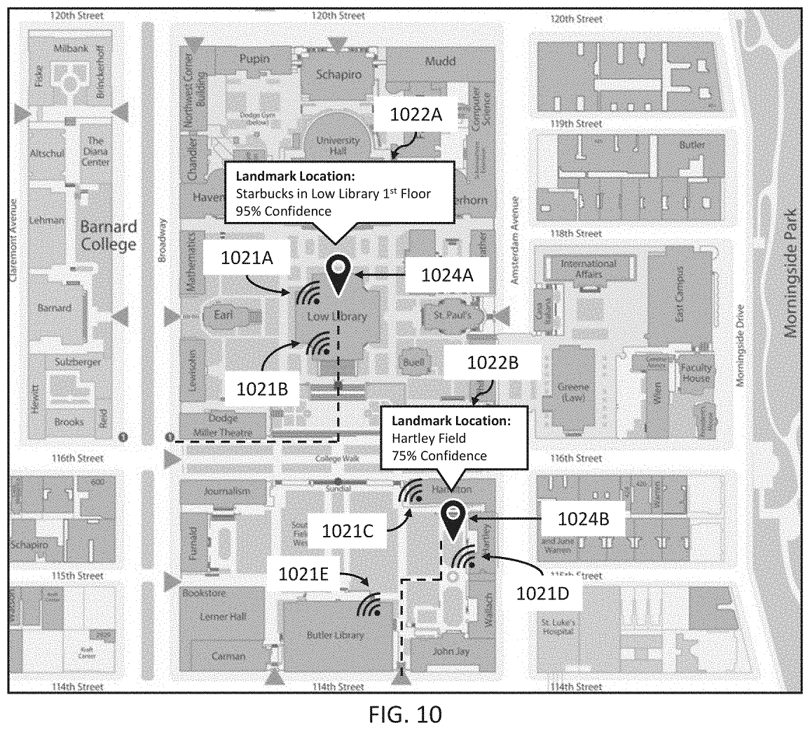

As shown here, representative area 726D can be defined around landmarks such as Federal Hall and Hanover Square as described in FIGS. 10. An irregular shape may be defined in various ways including using a drawing tool (not shown) to construct an irregular shape. The irregular shape may be converted into geocoordinates for the geospatial analysis. For example, here the representative area may be approximated as an irregular polygon for the spatiotemporal analysis.

A different timeframe may be applied to static and dynamic data for spatiotemporal analysis. Specifically, static data may be returned over a longer timeframe as compared to dynamic data. For example, static data about location of building cameras on the front and back door of federal hall (e.g., 718D1 and 718D2) may be returned over a longer timeframe, such as a year. In contrast, dynamic data such as location of police (718D3) stationed at Hanover Square may be returned over a shorter timeframe, such as the 10 minutes.

### Identification of Emergency Response Assets

In some embodiments, an emergency spatiotemporal analysis includes identifying one or more emergency response assets. In some embodiments, an emergency response asset is a device or system that can be leveraged or otherwise utilized to expedite or improve emergency response. In some embodiments, an emergency response asset is a non-human device or apparatus that can be remotely activated to perform a physical emergency response function. In some embodiments, activation of the emergency response asset includes opening or releasing a locking mechanism that secures the asset to its original starting location. For example, the emergency response asset can be an automated external defibrillator with a built-in locking mechanism that keeps it locked to an on-site fixed storage unit (hereinafter, “smart AED”). The storage unit can be an enclosure (partial or wholly enclosed) that protects the emergency response asset from the elements and/or theft or vandalism. The storage unit may include visually distinctive elements such as one or more of design(s), colors, patterns, and/or lights (e.g., neon/bright/flashing lights similar to emergency vehicle lights) to grab the attention of passersby and/or first responders when the corresponding emergency response asset is activated. In some cases, the visually distinctive elements are apparent or show only when the emergency response asset is activated. For example, flashing lights may turn on along with an audio requesting assistance when a call taker remotely activates the emergency response asset. The visually distinctive elements can be present on the storage unit and/or the emergency response asset. In some embodiments, the emergency response asset is secured without requiring a storage unit. For example, an emergency response asset may be a drone carrying a medical kit that is secured to a fixture on the roof of a building via a locking mechanism, and release of the locking mechanism enables the drone to maneuver to the emergency location pursuant to instructions provided via the asset controls of the emergency response application by the remote user (e.g., call taker). The asset controls can be directly manipulated as virtual controls through the GUI interface of the application and/or physical controls that are in communication with the application (e.g., joystick, mouse, or other input devices connected to the computing device running the emergency response application).

The emergency response assets can include non-human systems, devices, apparatuses, kits, or other equipment that can be used to respond to, address, or provide assistance in an emergency situation. Examples of emergency response assets include, but are not limited to: mobile communication devices, digital cameras, smart building systems, drones, automated external defibrillators (AEDs), and telemedicine systems. In some embodiments, emergency response assets are managed by an asset management system (AMS), which may be a component of an emergency management system (as described above) or provided by an independent asset service provider (ASP). The AMS communicates directly with emergency response assets to activate and control the emergency response assets. In some embodiments, an emergency response asset must be registered with the EMS or AMS before the emergency response asset can be accessed by an ESP. In some embodiments, an emergency response asset can include any or all of a display, one or more software modules, a data storage, a user interface, an asset network component, an asset location component, one or more sensors, and one or more processors. In some embodiments, an asset management system (AMS) can include any or all of one or more servers, one or more software modules, an AMS communication element, a user interface, and one or more AMS databases, which may include an asset database. The asset database can include data and information about one or more emergency response assets managed by the AMS, such as locations, geofences, and availability statuses associated with emergency response assets. In some embodiments, the components of an emergency management system (EMS) and an asset management system (AMS) function cooperatively to gather information regarding one or more emergency response assets, relay the information regarding the one or more emergency response assets to an emergency service provider (ESP), and provide access to the one or more emergency response assets to the ESP.

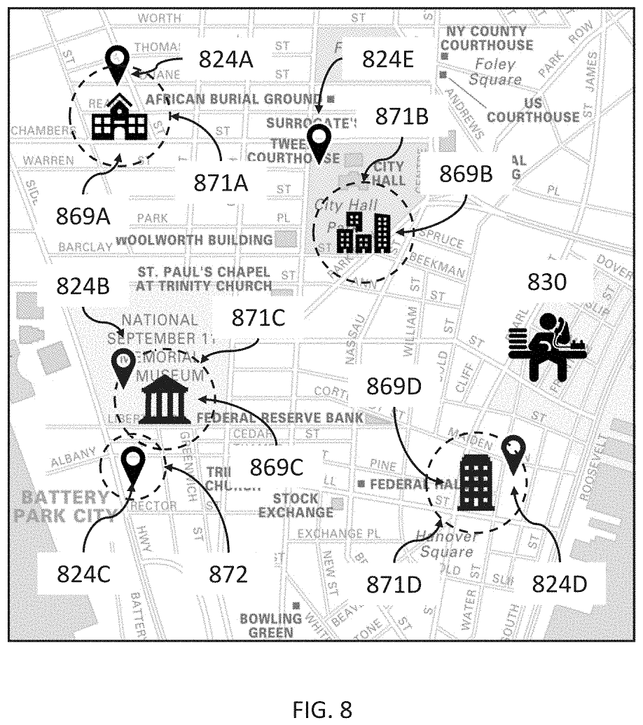

FIG. 8 illustrates a set of emergency response assets, a set of geofences associated with the set of emergency response assets, and various emergency locations. In the example illustrated by FIG. 8, each of the emergency response assets 869 are smart building systems. For example, emergency response asset 869A is a school building, emergency response asset 869B is an office building, emergency response asset 869C is a federal court building, and emergency response asset 869D is an apartment building. Each of the smart building systems has an associated geofence (geofences 871A-871D, respectively). ESP 830 has a jurisdiction that covers all of the emergency response assets 869. As mentioned above, when the EMS receives an emergency location, the EMS or AMS can retrieve a set of geofences associated with a set of emergency response assets and determine if the emergency location falls within any of the geofences. For example, in the example illustrated in FIG. 8, if the EMS receives emergency location 824A, the EMS or AMS (which may be a component of the EMS, in some embodiments) can retrieve the geofences 871A-871D associated with emergency response assets 869A-869D and determine if emergency location 824A falls within any of the geofences 871A-871D. As illustrated in FIG. 8, emergency location 824A does fall within the geofence 871A associated with the emergency response asset 869A (the school building) and only within geofence 871A. In some embodiments, the EMS can then transmit information regarding emergency response asset 869A (e.g., a link to an application for controlling the smart building system at the school building, as described below) to ESP 830. In another example, if the EMS receives emergency location 824E, the EMS or AMS can retrieve the geofences 871A-871D and determine that the emergency location 824E does not fall within any of the geofences 871A-871D. Thus, in this example, there are no emergency response assets available for emergency location 824E.

In some embodiments, the EMS can apply a radius around an emergency location to generate a range 872 (also referred to as a “location range”) and determine if the location range 872 overlaps with a geofence associated with an emergency response asset. The location range 872 may be defined by a radius of any predetermined or dynamic value (e.g., 100 meters, 0.5 miles, etc.). For example, in the example illustrated by FIG. 8, emergency location 824B falls directly within the geofence 871C associated with the emergency response asset 869C (the federal court building). Emergency location 1124C does not fall directly within the geofence 871C associated with the federal court building; however, when a range 872 (e.g., a radius of 0.5 miles) is applied to the emergency location 824C, the location range 872 does overlap with the geofence 871C associated with the federal court building, and thus emergency response asset 869C may be available for emergency location 824C. A range may be applied to an emergency location in various ways. For example, a range may be dynamically applied to an emergency location based on the type of emergency represented by the emergency location. For example, a range applied to an emergency location representing a medical emergency may be smaller (e.g., 100 meters) than a range applied to an emergency location representing a fire (e.g., 0.5 miles).

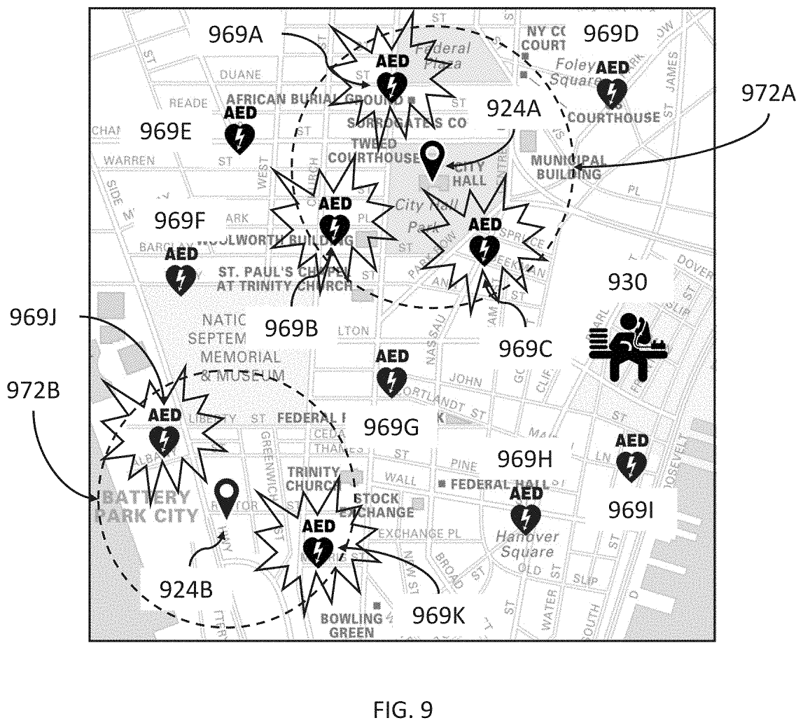

FIG. 9 illustrates processes for determining if there are emergency response assets available for an emergency location. FIG. 9 illustrates a set of emergency response assets, a pair of emergency locations, and location ranges associated with each of the emergency locations. In the example illustrated by FIG. 9, each of the emergency response assets 969A-969K are smart AEDs (e.g., automated external defibrillators with internet connectivity) stationed throughout Lower Manhattan. The smart AEDs have built-in lights and sirens that can be remotely activated when an emergency occurs in the vicinity of the smart AED, and a digital screen that shows a map of where the emergency is occurring, so that a bystander may be alerted of the emergency and then take the AED to the emergency as quickly as possible. In this way, a smart AED may be able to arrive at the scene of an emergency significantly faster than an ambulance, potentially saving a life. In some embodiments, such as in the example illustrated by FIG. 9, when the EMS receives an emergency location (e.g., emergency location 924A), the EMS or AMS can generate a location range (e.g., location range 972A) around the emergency location, as described above. The EMS or AMS can then determine if the location of any emergency response assets fall within the location range. For example, in the example illustrated by FIG. 9, location range 972A has been applied to emergency location 924A. As illustrated, three smart AEDs, emergency response assets 969A-969C, fall within location range 972A and are thus determined to be available for emergency location 924A. The lights and sirens built into those three smart AEDs can then all be activated (e.g., in response to user interactions with asset controls by a call taker at ESP 930, as described below), as illustrated by FIG. 9, in response to the emergency represented by emergency location 924A. The rest of the smart AEDs (e.g., emergency response assets 969D-969K) remain inactivated. In another example illustrated by FIG. 9, location range 972B has been applied to emergency location 924B. As illustrated, only two smart AEDs, emergency response assets 949J and 969K fall within location range 972B.

In some embodiments, after receiving an emergency location and determining that one or more emergency response assets is available for the emergency location, as described above, the EMS or AMS can automatically activate the one or more emergency response assets. For example, in the example illustrated in FIG. 9, after receiving emergency location 924B and determining that emergency response assets 969J and 969K (smart AEDs) are available for emergency location 924B, the EMS or AMS can automatically activate emergency response assets 969J and 969K, such as by remotely turning on the lights and sirens built into the smart AEDs. Because emergency response assets can take many different forms (e.g., smart AEDs, drones, smart building systems, etc.), the activation of an emergency response asset can take many different forms as well. For example, the activation of a drone type emergency response asset may involve deploying the drone to an emergency location, while the activation of a smart building system may involve locking one or more doors or accessing a video feed from a surveillance camera. In some embodiments, as mentioned above, after the EMS or AMS receives an emergency location and determines that one or more emergency response assets are available for the emergency location, the EMS or AMS can transmit information regarding the one or more emergency response assets to an ESP, and then activate the one or more emergency response assets according to user interaction(s) with asset controls by the ESP, as described below. In some embodiments, emergency response assets, once they have been activated, can be controlled by one or more users, either remotely or directly.

### Determination of Place-Based Locations

As mentioned above, in some embodiments, an emergency spatiotemporal analysis may additionally or alternatively include determining one or more relational attributes of an emergency response element, such as a landmark location for an emergency alert. FIG. 10 illustrates a process for determining a common location (e.g., a “place-based location” or a “landmark location”) for an emergency alert in accordance with one embodiment of the present disclosure. A common location is a location communicated in terms of real-world locations, such as a street address or a building name. In some embodiments, a common location is a place-based location, which is not a street address or a set of coordinates but instead uses names of buildings and places (e.g., parks or other landmarks) to describe a location. As described above, in some embodiments, an emergency management system (EMS) is configured to receive an emergency alert including an emergency location (e.g., a hybrid device-based location) and transmit the emergency location to an emergency service provider (ESP). In many instances, an emergency location received within an emergency alert is a coordinate location, such as a latitude and longitude pair. Disclosed herein are systems and methods for generating, alternatively or in addition to an emergency location received within an emergency alert, a common location for the emergency alert.

In some embodiments, when the EMS receives an emergency alert including an emergency location from an electronic device, the EMS can reverse geocode the emergency location to determine the nearest street address to the emergency location. In some embodiments, when the EMS receives an emergency alert from an electronic device (e.g., when a mobile phone generates an emergency alert, such as in response to an emergency phone call being made from the mobile phone), the EMS obtains information regarding one or more wireless signals within detectable range of the electronic device and uses the information regarding the one or more wireless signals to determine a place-based location for the emergency alert. For example, at any given time an electronic device may detect one or more WiFi signals, Bluetooth signals, cellular signals, or other radio frequency signals, whether or not the electronic device is communicatively coupled to the source(s) of the signal(s). Those wireless signals may provide information regarding the wireless signals, such as a MAC address, the name of a WiFi network, the address or location of the source(s) of the wireless signal(s), etc. Additionally, the electronic device may generate information regarding the one or more wireless signals, such as a signal strength (e.g., a received signal strength indicator (RSSI)).

The EMS then obtains information regarding the one or more wireless signals within detectable range of the electronic device. In some embodiments, the electronic device is configured to include any available information regarding the one or more wireless signals to the EMS within the emergency alert. In some embodiments, in response to receiving the emergency alert from the electronic device, the EMS prompts the electronic device to retrieve information regarding the one or more wireless signals within detectable range of the electronic device. In response, the electronic device can gather the information regarding the one or more wireless signals within detectable range of the electronic device directly, or the electronic device can communicate with the source(s) of the one or more wireless signals to receive the information regarding the one or more wireless signals. Once retrieved by the electronic device, the electronic device can then transmit the information regarding the one or more wireless signals to the EMS.

Once the EMS obtains the information regarding the one or more wireless signals within detectable range of the electronic device, the EMS can use the information regarding the one or more wireless signals to determine a common location (e.g., a place-based location) for the emergency alert. In some embodiments, the EMS can determine a common location for an emergency alert generated by an electronic device by using the name of a wireless signal within detectable range of the electronic device. In some embodiments, the EMS uses the RSSIs of two or more wireless signals within detectable range of the electronic device to determine which source the electronic device is nearest to and then uses information regarding the wireless signal from that nearest source to determine a common location. In some embodiments, the information regarding the one or more wireless signals within detectable range of the electronic device includes an identifier of the one or more wireless signals, which the EMS can then use to communicate directly with the source(s) of the one or more wireless signals and receive a common location from the source(s) of the one or more wireless signals. In some embodiments, the EMS uses the information regarding the one or more wireless signals within detectable range of the electronic device to additionally determine a confidence score for the determined common location.

FIG. 10 illustrates the Columbia University campus in New York City and two emergency alerts (represented by emergency locations 1024A and 1024B) received by the EMS. In a first example, the electronic device that generated the emergency alert represented by emergency location 1024A detects two wireless signals 1021 from two respective sources: WiFi network 1021A and WiFi network 1021B. In this example, WiFi network 1021A is the WiFi network of a Starbucks in Low Library and WiFi network 1021B is the WiFi network for Low Library itself. In this example, the emergency alert represented by emergency location 1024A included the RSSIs of wireless signals 1021A and 1021B, and the RSSI of wireless signal 1021A is twice as strong as the RSSI of wireless signal 1021B. Using this information, the EMS is able to determine that the emergency alert represented by emergency location 1024A was most likely generated within the Starbucks. Thus, in this example, a place-based location 1022A determined for the emergency alert represented by emergency location 1024A is “Starbucks in Low Library 1^{st} Floor” with 95% confidence. In a second example, the electronic device that generated the emergency alert represented by emergency location 1024B detects three wireless signals 1021 from three respective sources: WiFi networks 1021C-1021E. In this example, WiFi network 1021C is the WiFi network for the Hamilton building, WiFi network 1021D is the WiFi network for the Hartley building, and WiFi network 1021E is the WiFi network for Butler Library. In this example, the emergency alert represented by emergency location 1024B did not include any information regarding wireless signals within detectable range of the electronic device that generated the emergency alert, so the EMS transmits a request for wireless signal information to the electronic device that generated the emergency alert, and the electronic device sends back a response communication including information regarding wireless signals 1021C-1021E. Because the electronic device has detected these three wireless signals, the EMS determines through triangulation that the emergency alert represented by emergency location 1024B was likely generated in the field in front of Hartley field. Thus, in this example, a place-based location 1022B determined for the emergency alert represented by emergency location 1024B is “Hartley Field” with 75% confidence.

### Transmission and Presentation of Spatiotemporal Data

In some embodiments, after an emergency spatiotemporal analysis is performed, the EMS then transmits the results of the emergency spatiotemporal analysis (e.g., emergency response resources identified as having a location attribute that falls within the representative area of the emergency spatiotemporal analysis and a time attribute that falls within the timeframe of the emergency spatiotemporal analysis; hereinafter, “spatiotemporal data” or “emergency spatiotemporal data”) to one or more recipients, such as an emergency service provider (ESP). In some embodiments, the EMS pushes the spatiotemporal data to a recipient (as described above). In some embodiments, the spatiotemporal data is pulled from the EMS by a recipient (as described above).

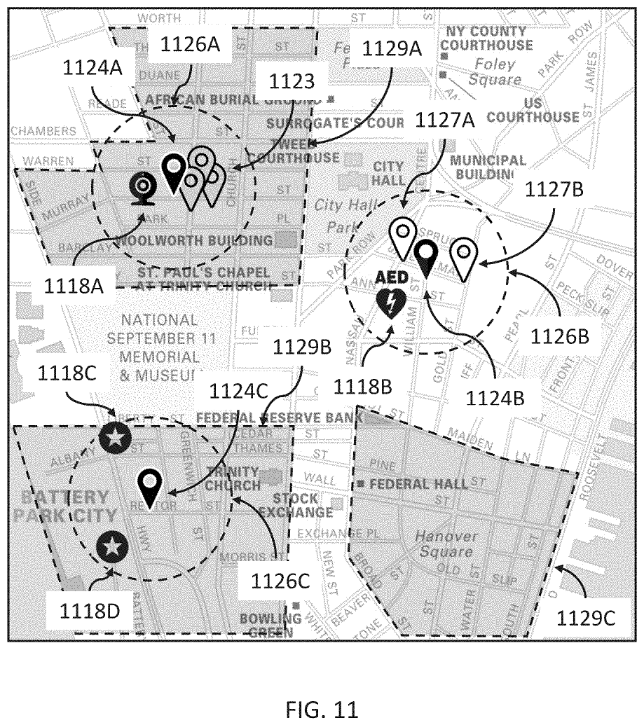

FIG. 11 illustrates processes for pushing spatiotemporal data to a recipient (e.g., an ESP). FIG. 11 illustrates three different geofences 1129A, 1129B, and 1129C associated with three respective emergency service providers (ESPs). ESP A, ESP B, and ESP C. In one example, the EMS receives a first emergency alert including emergency location 1124A. The EMS applies a default radius to generate representative area 1126A, applies a default timeframe of the past hour, and performs an emergency spatiotemporal analysis on representative area 1126A. The emergency elements identified by the emergency spatiotemporal analysis performed on representative area 1126A (e.g., the spatiotemporal data) include a group of three historical emergency alerts 1123 and smart camera 1118A. In this example, the EMS also uses a geofencing system to determine that emergency location 1124A falls within geofence 1129A associated with ESP A, as described above. The EMS can then tag the emergency alert represented by emergency location 1124A, emergency location 1124A, and/or the spatiotemporal data produced by the emergency spatiotemporal analysis performed on representative area 1126A with an identifier of ESP A. In response to tagging the spatiotemporal data with the identifier of ESP A, the EMS can automatically push the spatiotemporal data to ESP A if there is an active or persistent communication link established between ESP A and the EMS. Before pushing the spatiotemporal data to ESP A, the EMS may also associate the spatiotemporal data with the emergency alert represented by emergency location 1124A, because spatiotemporal data was produced by an emergency spatiotemporal analysis triggered by the emergency alert.

In a second example, a second emergency alert including emergency location 1124B is received by the EMS. As illustrated by FIG. 11, the EMS generates representative area 1126B by applying a radius to emergency location 1124B and performs an emergency spatiotemporal analysis on representative area 1126B using the same past one hour timeframe, yielding three emergency response resources: concurrent emergency locations 1127A and 1127B and smart AED 1118B. However, as illustrated by FIG. 11, emergency location 1124B does not fall within any geofence associated with any ESPs registered with the EMS, so the spatiotemporal data produced by the emergency spatiotemporal analysis performed on representative area 1126B (e.g., the three emergency response resources) is not pushed to any recipients.

In a third example, a third emergency alert including emergency location 1124C is received by the EMS. As illustrated by FIG. 11, the EMS generates representative area 1126C by applying a radius to emergency location 1124C and performs an emergency spatiotemporal analysis on representative area 1126C using the same past one hour timeframe from the previous two examples. In this example, the emergency spatiotemporal analysis produces two emergency response resources, police units 1118C and 1118D. The EMS also determines that emergency location 1124C falls within geofence 1129B associated with ESP B and, in response, tags the emergency alert associated with emergency location 1124C, emergency location 1124C, and/or the spatiotemporal data produced by the emergency spatiotemporal analysis performed on representative area 1126C (e.g., the two police units 1118C and 1118D) with an identifier of ESP B and pushes the spatiotemporal data to ESP B if there is an active or persistent communication link established between ESP B and the EMS. In the examples illustrated by FIG. 11, none of the emergency locations 1124 fall within geofence 1129C associated with ESP C, so no spatiotemporal data is pushed to ESP C, even if there is an active or persistent communication link established between ESP C and the EMS.

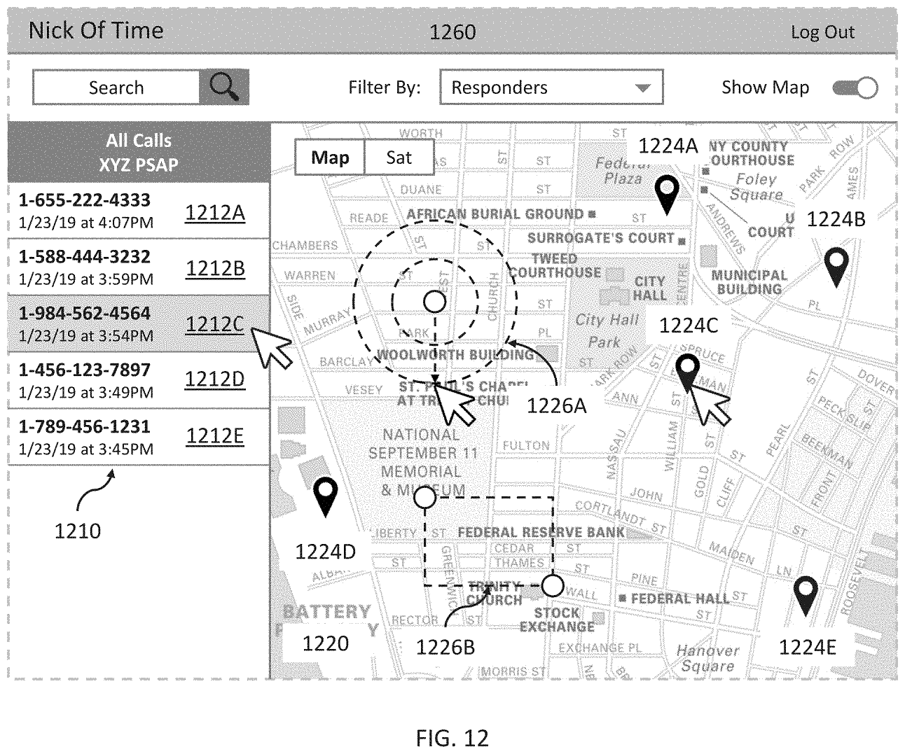

As mentioned above, in some embodiments, the EMS performs an emergency spatiotemporal analysis in response to receiving an emergency data request including an indicator of a representative area for the emergency spatiotemporal analysis from a requesting party (e.g., an ESP) and transmits any spatiotemporal data produced by the emergency spatiotemporal to the requesting party (e.g., spatiotemporal data is pulled from the EMS by the requesting party). FIG. 12 illustrates processes for generating and transmitting an emergency data request including an indicator of a representative area. In some embodiments, an emergency data request including an indicator of a representative area is generated and transmitted by a backend system without the use of a user interface. In some embodiments, an emergency data request including an indicator of a representative area is generated and transmitted through a graphical user interface (GUI) of an emergency response application, as illustrated by FIG. 12.

FIG. 12 illustrates various examples of processes for generating and transmitting an emergency data request including an indicator of a representative area to an EMS using an emergency response application 1260. For example, in some embodiments, a user of the emergency response application 1260 can generate and transmit an emergency data request including an indicator of a representative area to the EMS by selecting an incident 1212 from within the list of incidents 1210 or by selecting an emergency location 1224 within the interactive map 1220. Selecting an emergency location 1224 or an incident 1210 prompts the emergency response application 1260 to generate and transmit an emergency data request to the EMS including the emergency location 1224 or the emergency location associated with the incident 1210 as the indicator of the representative area. In some embodiments, the EMS can then generate or determine the representative area by applying a radius to the emergency location 1224 or the emergency location associated with the 1210, as described above. For example, FIG. 12 illustrates five incidents 1212 (incidents 1212A-1212E) associated with five respective emergency locations 1224 (emergency locations 1224A-1224E) within the GUI of the emergency response application 1260. In this example, if a user of the emergency response application 1260 selects incident 1212C or its associated emergency location 1224C, the emergency response application 1260 will be prompted to generate and transmit an emergency data request to the EMS including emergency location 1224C as an indicator of a representative area.

In another example, a user of the emergency response application 1260 can generate an emergency data request including an indicator of a representative area by defining a geospatial boundary within the interactive map 1220. For example, in some embodiments, a user of the emergency response application 1260 can define a geospatial boundary by clicking and dragging with their mouse to create a circle out of a point and a radius, such as the circular geospatial boundary representing representative area 1226A, or by clicking in two points to create a rectangle out of the two points, such as the rectangular geospatial boundary representing representative area 1226B. In this example, defining a geospatial boundary within the interactive map 1220 prompts the emergency response application 1260 to generate and transmit an emergency data request to the EMS including the geospatial boundary representing as an indicator of the representative area. In some embodiments, the EMS can then generate or determine the representative area by rastering a geospatial boundary representing a representative area. In some embodiments, an emergency response application sends an emergency data request including an identifier of an ESP as an indicator of a representative area to the EMS. Using the identifier of the ESP, the EMS can then retrieve a geofence associated with the ESP and use the geofence associated with the ESP as the representative area for an emergency spatiotemporal analysis. In some embodiments, an emergency response application automatically transmits an emergency data request including an indicator of a representative area (e.g., an identifier of an ESP, such as the ESP at which the emergency response application is being accessed) to the EMS in response to a user logging into the emergency response application.

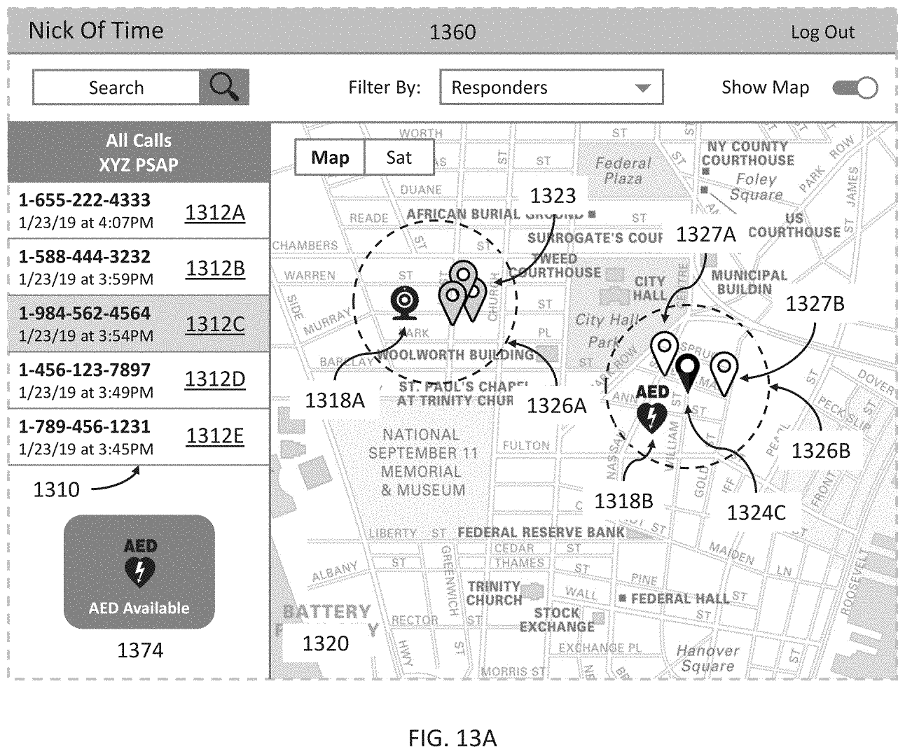

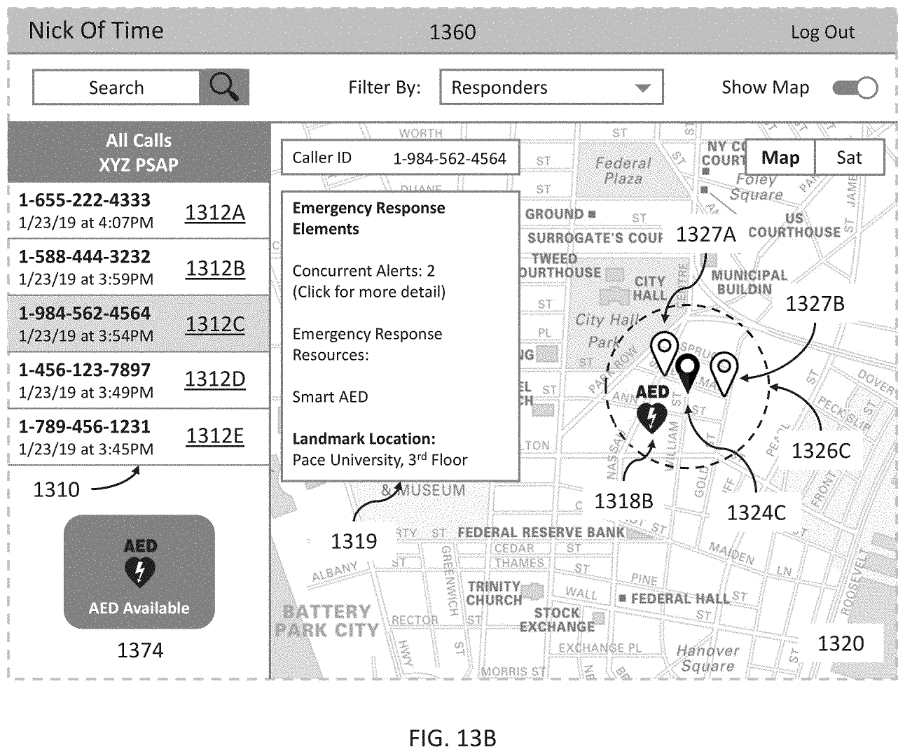

As mentioned above, in some embodiments, after performing an emergency spatiotemporal analysis on a representative area, the EMS can transmit spatiotemporal data produced by the emergency spatiotemporal analysis to one or more recipients. FIGS. 13A and 13B illustrate spatiotemporal data received by an emergency service provider (ESP) and displayed within an emergency response application. As illustrated in FIG. 13A, two emergency spatiotemporal analyses have been performed, one on representative area 1326A and another on representative area 1326B. In the examples illustrated by FIG. 13A, the emergency spatiotemporal analyses performed on representative areas 1326A and 1326B are the same analyses performed on representative areas 1126A and 1126B, respectively, described in reference to FIG. 11. As illustrated by FIG. 13A, the results of the respective emergency spatiotemporal analyses have been transmitted to an ESP (as described above) and are now displayed within an emergency response application 1360 accessed by a member of the ESP. For example, within representative area 1326A (defined in this example by the click and drag gesture illustrated in FIG. 12 used to create the geospatial boundary representing representative area 1226A, thereby prompting the emergency response application to generate and transmit an emergency data request including the geospatial boundary representing representative area 1226A as an indicator of a representative area to the EMS) the EMS has identified a group of three historical emergency locations 1323 and a smart camera 1318A, now displayed within the representative area 1326A within the GUI of the emergency response application 1360. In another example, within representative area 1326B (automatically defined by the EMS by a radius applied to emergency location 1324C in response to receiving an emergency data request including emergency location 1324C as an indicator of a representative area) the EMS has identified two concurrent emergency locations 1327A and 1327B and a smart AED 1318B, now displayed within the representative area 1326B within the GUI of the emergency response application 1360. Additionally, the emergency response application also displays asset controls 1374 for activating the smart AED 1318B. In some embodiments, spatiotemporal data displayed within the emergency response application 1360 can be filtered based on type, such as responders, emergency response assets, concurrent emergency alerts, or historical emergency alerts. In some embodiments, as illustrated by FIG. 13B, selecting an incident 1312 or an emergency location 1324 representing an emergency alert prompts the emergency response application 1360 to display spatiotemporal data associated with the emergency alert within a data card within the GUI of the emergency response application 1360. For example, as illustrated by FIG. 13B, incident 1312C or its associated emergency location 1324C has been selected by a user of the emergency response application, and the emergency response application 1360 now displays the spatiotemporal data produced by an emergency spatiotemporal analysis performed on the representative area 1326B generated around emergency location 1324C within data card 1319. In this example, the data card 1319 lists both of the concurrent emergency locations, the smart AED, and a common location generated for the emergency alert. In some embodiments, after an emergency data request including an indicator of a representative area (e.g., an identifier of an ESP) is received from a requesting party (e.g., an ESP) by the EMS, the EMS can establish an active or persistent communication link with the requesting party, as described above. Then, in addition to performing an emergency spatiotemporal analysis on the representative area and transmitting any spatiotemporal data produced by the emergency spatiotemporal analysis to the requesting party, whenever any new or additional emergency response resources having a spatial attribute falling within the representative area are received or found by the EMS, the EMS can automatically push the new or additional emergency response resources to the requesting party.

### Emergency Metrics

Emergency metrics can be illustrative tools for an ESP agency for effective and efficient emergency management and response. In legacy systems, ESP agencies could not easily generate and view emergency metrics due software incompatibility and data fragmentation, particularly as emergencies are happening in real-time. In the present invention, methods and systems are contemplated for customized views for ESP agencies (e.g., a PSAP) for their own emergency metrics. In some embodiments, the emergency metric can be displayed as a standalone, e.g., percentage of repeated calls.

In other embodiments, the emergency metric is displayed on a map where the underlying data included in the emergency alert is also represented. In some embodiments, the emergency metric is displayed on a graphical timeline or on a map such as a call density map. One advantage of the displaying the call volume data in a graph on a timeline is that the variability of the call data can be visualized as opposed to getting an average number. In a similar way, a call density map shows clusters of calls from certain locations for better emergency management.

Previously, ESP agencies could not get customized emergency metrics comparing the individual ESP agency with peer agencies for similar reasons. In the present invention, methods and systems are disclosed for viewing and comparing an ESP agency with other peer agencies (e.g., neighboring agencies) or within a region (e.g., Florida state, northern Florida, Orlando area).

As used herein, “emergency metrics” refers to results from spatiotemporal analysis of emergency data, where emergency alerts are aggregated within a representative (e.g., jurisdictional boundaries of PSAP-1). Some exemplary and non-limiting emergency metrics includes call volume, call density, call duration, time between calls, percentage of repeated calls, total number of emergency service requests, percentage of emergency service requests declined, calls shared with neighboring ECCs (e.g., neighboring PSAPs), call source, spoken language, emergency type, emergency location type.

### Regional Views

Regional agencies (also referred to as regional authorities) may oversee several smaller primary agencies that are tasked with responding to emergencies. The regional agency may be a state authority, e.g., California Governor's Office of Emergency Services (Cal OES), which may be responsible for emergency management and preparedness for an entire state.

Fragmentation of emergency services within a specific jurisdiction often results in scatter of emergency data in several primary agencies, secondary agencies and other bodies. Often, the computer systems and software are interoperable between agencies. Moreover, the combination of public and private emergency service providers often leads to distinct pools of emergency data at different sources within an area (e.g., a county, town, city, region or state). Sometimes, different types of emergency data (e.g., fire, medical, police, disaster management, environmental/chemical hazards) may be available from different sources. The lack of standardization and/or harmonization of these emergency data sources pose a challenge to regional agencies which oversee emergency management on a large scale.

For example, a regional agency (such as a city or state emergency management entity) may be responsible for planning and overseeing PSAP 1, 2 and 3. In addition, PSAP 1, 2 and 3, may dispatch to one or more secondary agencies for responding to emergencies within the coverage area of the regional agency. In particular, state directors may not have good insights to the agencies scattered throughout their state. As the state directory or authority, they have a responsibility to their agencies to work with the governing authorities to provide continuing education, funding and training to all agencies within their covered area (e.g., a state). For example, state directors play a role in determining PSAP best practices relating to operations.

In certain embodiments, disclosed herein are devices, systems, and methods for providing emergency data for regional agencies to plan for efficient emergency response and asset management. Emergency data from various sources may be gathered about one or more primary agencies from various sources. The emergency data may be processed (e.g., by filtering, consolidation of duplicates, etc.) and provided for display for a regional agency. The regional agency may be credentialed to view emergency data within its area of coverage. Data may be displayed according to standards and norms and ease of use. In addition to emergency data, environmental data (e.g., weather, traffic, sensor data), health data (patient data, medical sensor readings) may also be added to provide additional information for the regional agency. Big data analytics and prediction algorithms may provide additional insights and planning tools.

In certain embodiments, disclosed herein are devices, systems, and methods for providing regional view of emergency data. Although smaller agency (e.g., a PSAP, a police station) of emergency data may be available, consolidated regional view for a particular agency may be needed. Consolidation of the primary or secondary agency emergency data may be done using geofencing analysis (e.g., by filtering emergency data by the geofence of the agency).

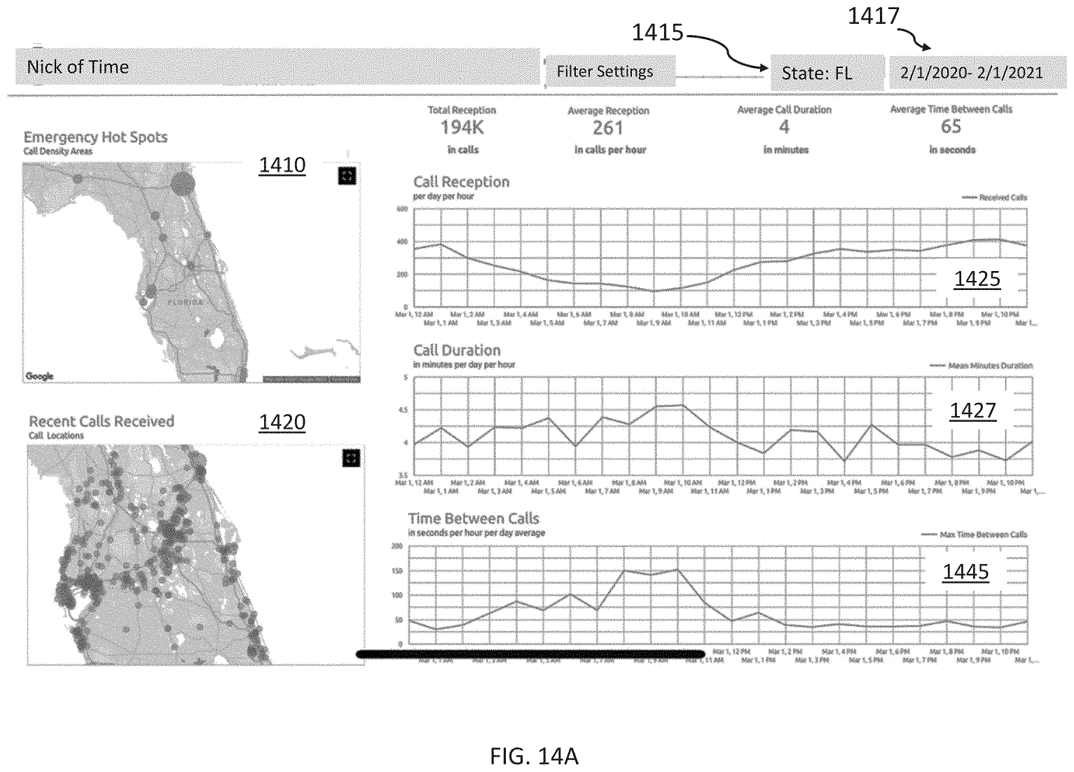

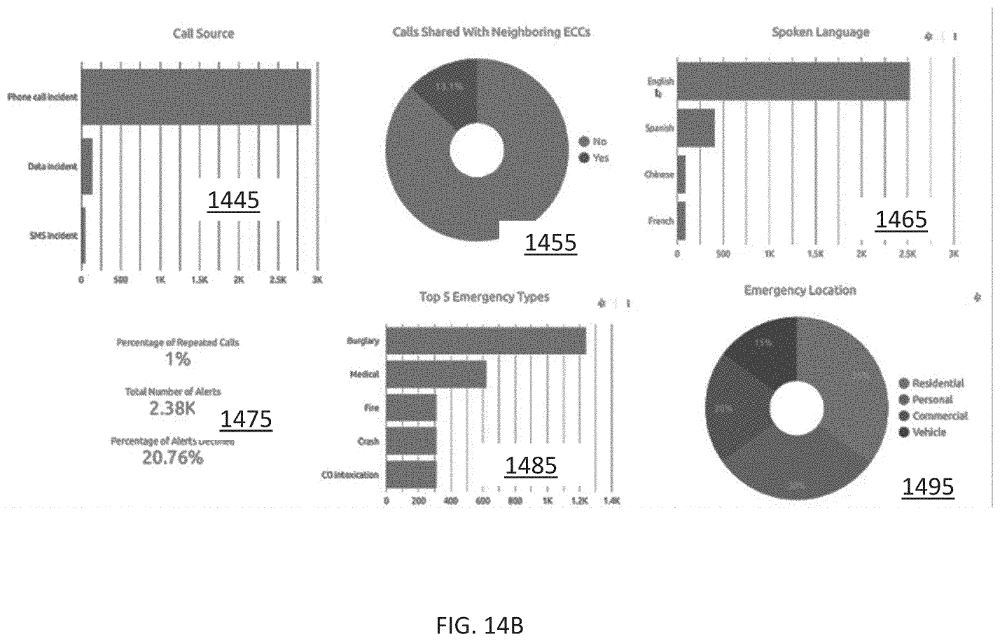

FIG. 14A illustrates an example of a graphical user interface (GUI) of emergency metrics for a regional agency. Call volume for emergency calls to primary agencies (PSAPs) in Florida is shown with lows and peaks for the month of February. Enlarge views of towns and cities in Florida are also depicted. Charts and graphs may be available for printing or downloading (e.g., in .csv, PDF or another format).

In some embodiments, a method for providing emergency metrics is disclosed. First, a representative area for emergency spatiotemporal analysis is defined. For example, the representative area may be defined by the jurisdictional boundaries of the ESP agency (e.g., Florida entered within box 1415). Emergency alerts that have come in within the representative area can be identified within a defined timeframe (e.g., Feb. 1, 2020 to Feb. 1, 2021 entered within box 1417).

As depicted, call volume or call reception 1425 for each primary agency is shown on the map over the defined timeframe (a year). Although not shown, other parameters that may be shown are location statistics regarding incident frequency, users, sources, etc. In some embodiments, hovering over the map is functional so that detailed information is displayed in inset when a user hovers over a specific point over the coverage area.

In addition to call densities, it is understood that alert densities may also be shown when an emergency call is not made. Instead, alternative mode of communication with the PSAP (e.g., SMS, alarms, etc.) are utilized for getting emergency help. For example, the emergency alert may be SMS messages, internet-based messaging, APIs, wherein the one or more emergency alerts are not accompanied by an emergency call. In some embodiments, the emergency alerts are verified by various known methods including a monitoring center and transmitted to the ESP agency without an accompanying emergency call.

In some embodiments, emergency metrics for analyzing emergency calls coming into an ESP agency can be generated (i.e., emergency calls initiated within the jurisdictional boundary of the ESP agency). For example, call duration for emergency calls coming into an ESP agency 1427 and time between calls 1429 can be visualized within the specific timeframe. Such metrics for an ESP agency could be compared with peer agencies as described in FIG. 14B.

In some embodiments, the emergency alerts or emergency calls may be aggregated to for understanding patterns, as depicted as clusters, as shown in 1410 and 1420. For example, a timeframe of a few days (e.g., 1-14 days) may be used to identify emergency hotspots (e.g., a large cluster has developed on the top-right Jacksonville area). In 1420, the focus is on recent call density clusters on the northern region of Florida on a shorter timeframe (e.g., 1-24 hours).

FIG. 14B illustrates an example of a graphical user interface (GUI) of emergency metrics for an ESP agency. As depicted, additional emergency metrics can be generated and displayed for the ESP agency by aggregating emergency alerts. For example, the call source 1445—phone call incident, data incident or SMS incident, etc.—indicates how the emergency alert was received and could be used to distribute telecommunicators for different roles and stations. Calls shared with neighboring ECC agencies 1455 (neighboring ESPs) indicates the percentage of alerts that solely within the ESP's jurisdiction, which may be helpful for resource allocation and coordination between neighboring ESPs. Spoken language 1465 shows percentage of callers with different languages and may help with planning interpretation services.

In some embodiments, additional emergency metrics are repeated calls (which indicates that the emergency may not have been resolved), total number of alerts and percentage of declined alerts (which could indicate that alert handling capacity should be increased). In particular, repeated calls could be particularly important emergency metric for emergency planning. In some embodiments, the emergency type 1485 could be generated and displayed for emergency management. For example, burglary is the largest type of emergency in this jurisdiction followed by medical, fire, vehicular crash and carbon monoxide intoxication. In addition, the type of places where emergencies are occurring (emergency location 1495) can be used for developing prevention strategies.

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device. In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random-access memory (FRAM). In some embodiments, the non-volatile memory comprises phase-change random access memory (PRAM). In some embodiments, the non-volatile memory comprises magneto resistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing-based storage. In further embodiments, the storage and/or memory device is a combination of devices such as those disclosed herein.

In some embodiments, the digital processing device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the digital processing device includes an input device to receive information from a subject. In some embodiments, the input device is a keyboard. In some embodiments, the input device is a pointing device including, by way of non-limiting examples, a mouse, trackball, trackpad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Certain Terminologies

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, a “device” is a digital processing device designed with one or more functionality. A “triggering device” refers to a communication device with a communication component, which will allow it to send and receive information over a wireless channel, a wired channel, or any combination thereof (e.g., sending/receiving information over the Internet). Examples of triggering devices include a mobile phone (e.g., a smartphone), a laptop, a desktop, a tablet, a radio (e.g., a two-way radio), and a vehicular communication system. In some embodiments, a triggering device includes a car security system (e.g., OnStar®), a home security system, or a home control system (e.g., a networked control system for providing network controlled and/or smart temperature control such as a Wi-Fi smart thermostat, lighting, entertainment, and/or door control, such as Nest^{R}). In some embodiments, a triggering device is an Internet of Things (IoT) device. In some embodiments, the triggering device is a sensor for sensing environmental or health indicators. In some embodiments, the sensor may include a sensing component and a communication component. In some embodiments, the triggering device is a sensor in a sensor network or a device that controls a sensor network.

In some embodiments, a triggering device is a wearable device (e.g., a communication device worn by a user). In some embodiments, a triggering device (e.g., a wearable device) comprises one or more sensors. As used herein, a “mobile wireless device” refers to a device that is portable and communicates wirelessly. In some embodiments, a user wears or carries the mobile wireless device on the user's person or in the user's vehicle. Examples of mobile wireless devices include mobile or cellular phones, wearable devices (e.g., smart watch, fitness tracker, wearable sensor, smart glasses, etc.).

As used herein, an “associated device” refers to a communication device that is associated with the triggering device. For example, a user may be using several communication devices such as a mobile phone, a wearable, a home security system, a car computer. The user may have registered these devices with his or her account and linked these devices with a user name, user number(s), email address(es), home or other physical address(es). In some embodiments, associated devices may include communication devices of a second user who is associated with user, e.g., a husband and wife, a father and son, a victim and doctor, friends, work colleagues, etc. In some cases, the user may have added the second user as an emergency contact, a member of a group, etc. In some cases, user may have agreed to share location and other data with the second user. In some embodiments, the second user may be someone who is frequently contacted by the user and the communication device identifies the second user from the “Recently called” or “Frequently called” list. In some embodiments, the associated devices may be devices that are proximal or near-by to the triggering device such as obtained through a Wi-Fi scan. In some embodiments, an associated device is proximal to the triggering device when the location of the associated device is within 1, 5, 10, 15, 20, 25, 30, 35, 40, 45, 50, 60, 70, 80, 90, 100, 200, 300, 400, or 500 meters of the location of the triggering device.

As used herein, the “list of associated devices” refers to a list of communication devices that are associated with the user or the triggering device (e.g., a second resident in a smart home). The list of associated devices may be listed by user name, phone number, email address, physical address, coordinates etc. The device entry in the list may include phone number, email address, physical address, coordinates, BSSID, SSID or MAC address. The list may be user defined or generated by the device or the EMS.

As used herein, a “emergency service request” refers to a request or message sent to an emergency service provider for emergency assistance. In some embodiments, a request for assistance is an emergency request for assistance (e.g., the request is associated with an emergency situation) such as, for example, an emergency alert. In some embodiments, an emergency alert comprises a request for assistance. In some embodiments, a request for assistance is associated with an emergency situation. In some embodiments, an emergency alert comprises an alarm, which has to be verified to be an emergency. For example, the source of the alarm may be a home security system, which may include sensors such as smoke alarms. The alarm may trigger an emergency alert, which may be verified by a monitoring center and sent to an emergency service provider to respond to a residential fire.

In some embodiments, a request for assistance comprises an emergency indication or a type of emergency. In further embodiments, an emergency indication is selected from one or more of the group consisting of traffic accident, police emergency, medical emergency, and fire emergency. In some embodiments, a request for assistance is associated with a non-emergency situation (e.g., request for a tow truck after car breaks down). In some embodiments, a request for assistance is associated with a device sending the request. In other embodiments, a request for assistance is associated with a device not sending the request (e.g., a proxy request on behalf of a second device and/or a member device in a group of devices). As used herein, a request is “associated” with a device or user when the request relates to an emergency or non-emergency situation involving the device or user. In some embodiments, a request comprises data associated with a device (or user thereof). In some embodiments, a request comprises a data set associated with a device. For example, in some embodiments, a request comprises a data set associated with a device, wherein the data set comprises current location data. In other embodiments, a request for assistance is sent and/or received separately from data associated with a device. For example, in some embodiments, a request is sent first, and the recipient subsequently queries the device that sent the request for data or a data set associated with the emergency and/or device or user involved in the emergency. Alternatively, in some embodiments, a request is sent first, and the recipient subsequently queries the device associated with the emergency for data or a data set associated with the emergency and/or device or user involved in the emergency.

As used herein, a “emergency responder” refers to any person or persons responsible for addressing an emergency situation. In some embodiments, a first responder refers to government personnel responsible for addressing an emergency situation. In some embodiments, a first responder is responsible for a particular jurisdiction (e.g., a municipality, a township, a county, etc.). In some embodiments, a first responder is assigned to an emergency by an emergency dispatch center. In some embodiments, a first responder responds to a request for emergency assistance placed by a user via a user communication device. In some embodiments, a first responder includes one or more fire fighters, police officers, emergency medical personnel, community volunteers, private security, security personnel at a university, or other persons employed to protect and serve the public and/or certain subsets of the population.

As used herein, an “emergency service provider” (ESP) is a public or private organization or institution responsible for providing emergency services. For example, in some embodiments, an EDC (e.g., a public safety answering point (PSAP)), a fire department, a police department, and a hospital may all be considered emergency service providers. In some embodiments, an emergency responder is a member of an ESP. In some embodiments, an ESP personnel is a person who works at an ESP. For example, an ESP personnel may be a call-taker at a PSAP or a first responder at a fire department.

As used herein, a “recipient” refers to one or more persons, services, or systems that receive a request for assistance (e.g., an emergency alert). The recipient varies depending on the type of request. In some embodiments, a recipient is an emergency service. In some embodiments, a recipient is an emergency service when he requests for assistance pertains to an emergency (e.g., a tier 2 emergency). In some embodiments, a recipient is an emergency management system. In some embodiments, a recipient is an emergency dispatch center. In some embodiments, a recipient is an emergency dispatch center, wherein the request is first routed through an emergency management system (e.g., request is sent to the EMS, but ultimately is sent to an EDC). In some embodiments, a recipient is a first responder (e.g., a communication device of a first responder). In some embodiments, a recipient is a non-emergency service or personnel, for example, a relative or friend. In such situations, a user of a communication device (or member device or second device) does not require emergency assistance, but does need help. As an example, a user of a member device in a group of devices is a child who is lost in a theme park. The parent of the child has a communication device in the same group of devices as the child's member device. The parent uses the communication device to send a request for assistance on behalf of the child's member device to theme park security guards who are closer to the child than the parent. Security is then able to pick up the child quickly using the data set associated with the member device, which they are given authorization to access by the parent's communication device.

As used herein, an “emergency data source” refers to any device, server, or system that can produce, generate, or communicate information or data pertinent to an emergency. In some embodiments, an emergency data source is a communication device, a wearable device, an internet of things (IoT) device, or any other type of device. In some embodiments, an emergency data source is a network server. As used herein, an “emergency data recipient” refers to any device, server, or system or user of any device, server, or system that can receive information or data pertinent to an emergency. In some embodiments, an emergency data recipient is an emergency service provider (ESP), ESP personnel, or an electronic device associated with an ESP. In some embodiments, an emergency data recipient is a person in an emergency or an electronic device associated with a person in an emergency.

As used herein, a “victim” refers to a person experiencing an emergency. As used herein, a “medical service provider” is a facility that provides people with medical services, such as a hospital, healthcare clinic, emergency room, urgent care center, etc. As used herein, a “preferred medical service provider” is a medical service provider covered under a victim's medical insurance or a medical service provider or has better (e.g., more optimal or less expensive) coverage under the victim's medical insurance than another medical service provider. In some embodiments, a preferred medical service provider may be referred to as an “in-network hospital” or “in-network medical service provider.” As used herein, a medical service provider is “proximal” to a location if the medical service provider is within the vicinity of the location (e.g., within 1 mile, 2 miles, 3 miles, 4 miles, or 5 miles of the location).

As used herein, a “user” refers to one or more person or persons associated with a device (e.g., communication device, member device, second device, device of a first responder, etc.). In some embodiments, a user utilizes a device to place a request for assistance. In some embodiments, user refers to one or more persons who are paid subscribers of a network access service, for example, cellular service subscribers. In some embodiments, a user refers to anyone who gains access to a network via a router, for example, a Wi-Fi router, and is not a paid subscriber of any access service. In some embodiments, a device associated with a user is a device carried or worn on the person of the user (e.g., a phone or wearable device). In some embodiments, a device associated with a user is not carried or worn on the person of the user (e.g., a home security sensor or camera installed in the home of the user, a vehicle tracking system installed in a vehicle of the user, etc.).

As used herein, “data” refers to a collection of information about one or more entities (e.g., user of a user communication device) and/or an environment that pertains to characteristics of the one or more entities. In some embodiments, an entity is a person. In some embodiments, an entity is a thing (e.g., a house). For example, in some embodiments, data comprises sensor data from home sensors associated with a house. In this example, the data is also associated with one or more persons (e.g., the homeowner(s) and/or inhabitant(s)). In some embodiments, data refers to meta-data. In some embodiments, data comprises health information about the user of a communication device. In some embodiments, data comprises information about the surrounding environment of the user of the user communication device (e.g., surrounding temperature, location, elevation, barometric pressure, ambient noise level, ambient light level, surrounding geography, etc.). In some embodiments, data comprises information about other users that is pre-stored in a device or in a database (e.g., a database within a group of devices who are related to the user of the user communication device as predefined by the user). In some embodiments, the data set comprises information from two or more users of user communication devices, wherein each user is affected by the current emergency situation. As an example, two unrelated users are involved in a vehicular collision, and each user sends a separate emergency request (for traffic accident) using his/her communication device. In this example, the separate emergency requests are associated (e.g., by an emergency management system and/or emergency dispatch center) with the same emergency based on the proximity of time, location, and emergency indication of the emergency requests. As a result, the data set for this accident comprises information from both user communication devices. In this example, the data set comprises location information from both devices (e.g., GPS coordinates), biosensor data for one or both devices (e.g., biosensor data such as heart rate and blood pressure can be important in case of injury), and information about the vehicle driven by each user (e.g., make, model, and year of manufacture information stored on the device). In some embodiments, data comprises current data. In further embodiments, current data comprises information that is equal to or less than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, or 60 minutes old. In further embodiments, current data comprises information that equal to or less than 1, 2, 3, 4, 5, 6, 7, 8, 9, 10, 11, 12, 13, 14, 15, 16, 17, 18, 19, 20, 21, 22, 23, or 24 hours old. In some embodiments, data comprises historical data. In further embodiments, historical data comprises information that is equal to or more than 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, or 60 minutes old. In further embodiments, historical data comprises information that equal to or more than 1, 2, 3, 4, 5, 6, 7, 8, 9, 10, 11, 12, 13, 14, 15, 16, 17, 18, 19, 20, 21, 22, 23, or 24 hours old. In some embodiments, the age of information is calculated from the date the information is first collected (e.g., when a sensor first detects a sensed parameter such as, for example, heart rate).

As used herein, “health data” refers to medical information associated with a user of a device. In some embodiments, health data comprises medical history such as, for example, past illnesses, surgery, food and/or drug allergies, diseases, disorders, medical diagnostic information (e.g., genetic profile screen), or any combination thereof. In some embodiments, health data comprises family medical history (e.g., family history of breast cancer). In some embodiments, health data comprises current health information such as, for example, current symptoms, current medications, and/or current illnesses or diseases. In some embodiments, health data comprises user age, height, weight, blood type, and/or other biometrics. In some embodiments, medical history comprises medical information that is equal to or more than 1, 2, 3, 4, 5, 6, 7, 8, 9, 10, 11, 12, 13, 14, 15, 16, 17, 18, 19, 20, 21, 22, 23, or 24 hours old. In some embodiments, medical history comprises medical information that is equal to or more than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days old. In some embodiments, current health information comprises information that is equal to or less than 1, 2, 3, 4, 5, 6, 7, 8, 9, 10, 11, 12, 13, 14, 15, 16, 17, 18, 19, 20, 21, 22, 23, or 24 hours old. In some embodiments, current health information comprises medical information that is equal to or less than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days old.

As used herein, “user data” refers to general information associated with a user of a device. In some embodiments, user data comprises user identity, user name, height, weight, eye color, hair color, ethnicity, national origin, religion, language(s) spoken, vision (e.g., whether user needs corrective lenses), home address, work address, occupation, family information, user contact information, emergency contact information, social security number, alien registration number, driver's license number, vehicle VIN, organ donor (e.g., whether user is an organ donor), or any combination thereof. In some embodiments, user data is obtained via user input.

As used herein, “sensor data” refers to information obtained or provided by one or more sensors. In some instances, a sensor is associated with a device (e.g., user has a communication device with a data link via Bluetooth with a wearable sensor, such as, for example, a heart rate monitor or a pedometer). Accordingly, in some embodiments, the device obtains sensor data from the sensor (e.g., heart rate from the heart rate monitor or distance traveled from the pedometer). In some instances, the sensor data is relevant to an emergency situation (e.g., heart rate during a cardiac emergency event). In some embodiments, a sensor and/or sensor device comprises an acoustic sensor, a breathalyzer, a carbon dioxide sensor, a carbon monoxide sensor, an infrared sensor, an oxygen sensor, an ozone monitor, a pH sensor, a smoke detector, a current sensor (e.g., detects electric current in a wire), a magnetometer, a metal detector, a radio direction finder, a voltage detector, an air flow meter, an anemometer, a flow sensor, a gas meter, a water meter, a Geiger counter, an altimeter, an air speed indicator, a depth gauge, a gyroscope, a compass, an odometer, a shock detector (e.g., on a football helmet to measure impact), a barometer, a pressure gauge, a thermometer, a proximity sensor, a motion detector (e.g., in a home security system), an occupancy sensor, or any combination thereof, and in some embodiments, sensor data comprises information obtained from any of the preceding sensors. In some embodiments, one or more sensors are physically separate from a user device. In further embodiments, the one or more sensors authorize the user device to obtain sensor data. In further embodiments, the one or more sensors provide or send sensor data to the user device autonomously. In some embodiments, the user device and the one or more sensors belong to the same group of devices, wherein member devices are authorized to share data. In some embodiments, a user device comprises one or more sensors (e.g., user device is a wearable device having a sensor or sensing component).

As used herein, “communication link” refers to a communication pathway from a device (e.g., communication device) to another device or to an intermediate device (e.g., a router) on a network. In some embodiments, the communication device establishes a communication link with another device or an intermediate device to transfer information (e.g., a location of the device) or to obtain information from a recipient such as, for example, location of a first responder assigned to a request for assistance associated with the communication device (e.g., device of first responder). A communication link refers to the point-to-point communication channels, point-to-point and end-to-end data sessions, and the physical hardware facilitating the communication channel(s) (e.g., antennas used to communicate/transmit information). In some embodiments, a data session comprises session parameters and the network route taken from one device to another device.

As used herein, a “data channel” refers to a communication session between two devices wherein data packets are exchanged between the devices. In some embodiments, a data session is setup using exchange of certain data packets, also called as “handshake signals,” which are able to define the capabilities of the data session. For example, in some embodiments, the data session “handshake” provides for the ability to transfer multi-media data, voice data, and other data via the data session. In some embodiments, the data session is setup without the use of handshake signals, wherein the two devices involved share data packets according to a predefined protocol (e.g., a previously agreed upon protocol). In some embodiments, the data session is routed through an EMS, which stores the multi-media, voice, and/or other data from any of the devices that are part of the data session. In further embodiments, the EMS shares the data from the data session with the other device (e.g., device of a first responder). In some embodiments, the EMS manages the data session.

As used herein, a “Received Signal Strength Indicator (RSSI)” refers to a measurement of the power present in a received radio signal. In some embodiments, the RSSI refers to a number assigned to the signal levels (e.g., power level) of packets as detected by a device receiving the packets from a device sending the packets. For example, an RSSI value may be a number within an arbitrary range such as from 0 to 100. In some embodiments, the RSSI refers to the decibel level of the power of the received data packets. In other embodiments, the RSSI refers to the actual power, for example measured in mW, as detected by the receiver. In some embodiments, RSSI is replaced with received channel power indicator (RCPI), which is a measure of the received radio signal power in a selected channel over the preamble and the entire received frame. As used herein, “voice or speech recognition software” refers to computer programs that can recognize a person's speech to identify trigger phrases (e.g., iListen, Voice Navigator, Google Now, LilySpeech, etc.). In some embodiments, the software may be able to recognize the identity of the speaker. As used herein, “voice command” refers to words or phrases that a user may use to give command to the triggering device. The trigger phrases may be user-defined or may be from a library of phrases on the trigger device or at a remote server.

As used herein, “sound detection software” refers to computer programs for detecting trigger sounds in and around the triggering device. The trigger sounds may be user-defined or may be from a library of phrases on the trigger device or at a remote server. The trigger sounds may be sounds (alarms, breakage, gunshots, explosion, fire, car crash, etc.) or absence of sound (e.g., no heartbeat, etc.). For example, a glass break detector software may use the microphone in the trigger device to monitor any noise or vibrations to detect burglaries in a smart home. If the vibrations exceed a baseline, they may be analyzed by the software. The software may analyze frequencies typical of glass shattering and trigger an emergency alert if the sound is above a trigger threshold. In some cases, the software may compare detected sounds with glass-break profiles analysis and trigger an alert if the amplitude threshold and/or statistically expressed similarity threshold are breached. In some embodiments, an emergency is detected or triggered when a trigger sound exceeds a threshold.

In some embodiments, a trigger sound threshold is about 50, 55, 60, 65, 70, 75, 80, 85, 90, 95, 100, 110, 120, 130, 140, 150, 160, 170, 180, 190, or 200 decibels. In some embodiments, a trigger sound threshold is at least about 50, 55, 60, 65, 70, 75, 80, 85, 90, 95, 100, 110, 120, 130, 140, 150, 160, 170, 180, 190, or 200 decibels. In some embodiments, a trigger sound threshold is no more than about 50, 55, 60, 65, 70, 75, 80, 85, 90, 95, 100, 110, 120, 130, 140, 150, 160, 170, 180, 190, or 200 decibels.

Modern communication devices, for example, smart phones, tablet computers, wearable communication devices, smart sensor devices and/or systems are often equipped with a variety of features for determining location information of the communication device using, for example, GPS, or triangulation with cellular phone towers. Modern communication devices also often include functionality to store data regarding a user of the communication device, for example, health information about the user.

In some embodiments, the communication device (or communication module of the device) communicates with a recipient through one or more data channels. In some embodiments, the recipient is an emergency management system. In some embodiments, the EMS routes communications to an EDC. In further embodiments, the EMS establishes a first data channel with the communication device and a second data channel between the EMS and the EDC, wherein the EMS bridges the first and second data channels to enable the communication device and the EDC to communicate. In some embodiments, the EMS converts data (e.g., data set) from the communication device into a format suitable for the EDC (e.g., analog or digital, audio, SMS, data, etc.) before sending or routing the formatted data to the EDC. In some embodiments, the EMS routes communications to a device associated with a first responder. In some embodiments, the communication device relays additional communications, information, and/or data sent or shared between member devices in the group of devices to the EMS or EDC after a request for assistance has been sent. In further embodiments, the additional information is relayed to the EMS or EDC after the request for assistance has been sent in order to provide current information that is relevant to the request. For example, in some instances, communications between member devices contain information relevant to the emergency (e.g., information that the user of member device who is experiencing a medical emergency suffers from diabetes). Accordingly, in some embodiments, the information is sent autonomously, at request of a user of the communication device, or at request of the recipient (e.g., EMS, EDC, first responder, etc.).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for providing emergency data comprising:
defining a representative area for emergency spatiotemporal analysis;
identifying one or more emergency response resources located within the representative area within a timeframe, wherein the length of the timeframe is based at least partly on information about the one or more emergency response resources or user input;
transmitting the emergency data comprising the one or more emergency response resources located within the representative area; and
displaying the emergency data comprising the one or more emergency response resources within an interactive map.

2. The method of claim 1, wherein the timeframe is based on type of resource.

3. The method of claim 1, wherein the timeframe cuts off based on expiration date or maintenance date.

4. The method of claim 1, wherein the timeframe is longer for static resources as compared to dynamic resources.

5. The method of claim 1, wherein the representative area is a circular shape, a regular or irregular polygon, a jurisdictional boundary for a public safety agency.6.

6. The method of claim 1, wherein the representative area is a regional agency, wherein the regional agency oversees a plurality of emergency service providers, each emergency service provider corresponding to a given geographic boundary and wherein the emergency data is aggregated among the plurality of emergency service providers.

7. The method of claim 1, wherein defining the representative area for emergency spatiotemporal analysis comprises receiving an emergency alert comprising an emergency location and generating a proximity area around the emergency location.

8. The method of claim 7, wherein generating the proximity area around the emergency location comprises applying a radius around the emergency location.

9. The method of claim 8, further comprising expanding the proximity area around the emergency location if no emergency response resources are identified within the proximity area.

10. The method of claim 1, further comprising providing a jurisdictional view for an emergency service provider, wherein the representative area is defined by one or more jurisdictional boundaries for the emergency service provider.

11. The method of claim 1, further comprising searching in a responder information database for emergency resources within the representative area and the timeframe, wherein the responder information database comprises information about responders, vehicles and facilities.

12. The method of claim 1, further comprising searching in a safety asset database for emergency resources within the representative area and the timeframe.

13. The method of claim 12, wherein safety assets comprise cameras, Iot devices, alarm sensors, door locks, fire extinguishers, drones, fire hydrants, AEDs, eye wash stations, first-aid kits, chemical burn kits, etc.

14. The method of claim 1, further comprising providing a prompt to a user to check on the status of an emergency resource.

15. A method for providing emergency metrics comprising:
defining a representative area for emergency spatiotemporal analysis;
identifying one or more emergency alerts within the representative area within a defined timeframe;
aggregating the emergency alerts into an emergency metric;
transmitting emergency metric associated with the one or more emergency alerts within the representative area to an emergency service provider; and
displaying the one or more emergency metric within an interactive map at the emergency service provider, wherein the representative area is within one or more jurisdictional boundaries of the emergency service provider.

16. The method of claim 15, wherein the defined timeframe is 1-14 days for identification of emergency hotspots.

17. The method of claim 15, wherein the one or more emergency alerts are emergency calls that were initiated within the representative area.

18. The method of claim 15, wherein the one or emergency alerts are emergency service requests that are sent via SMS messages, internet-based messaging, APIs, wherein the one or more emergency alerts are not accompanied by an emergency call.

19. The method of claim 15, wherein the one or more emergency alerts are aggregated into an emergency metric with a plurality of emergency alerts from outside the one or more jurisdictional boundaries of the emergency service provider.

20. The method of claim 19, wherein the emergency metric is one or more of call volume, call duration, time between calls, percentage of repeated calls, total number of emergency service requests, percentage of emergency service requests declined, calls shared with neighboring ECCs, call source, spoken language, emergency type, emergency location type.
